(19) United States
(12) Patent Application Publication
(10) Pub. No.: US 2025/0173630 A1
(43) Pub. Date: May 29, 2025

(54) SERVER APPARATUS, CONTROL METHOD OF SERVER APPARATUS AND NON-TRANSITORY COMPUTER-READABLE STORAGE MEDIUM

(71) Applicant: NEC Corporation, Tokyo (JP)

(72) Inventors: Shinnosuke NISHIMOTO, Tokyo (JP); Kenichi UEDA, Tokyo (JP); Yuki KOBAYASHI, Tokyo (JP); Yoshikazu ARAI, Tokyo (JP)

(73) Assignee: NEC Corporation, Tokyo (JP)

(21) Appl. No.: 18/938,380

(22) Filed: Nov. 6, 2024

(30) Foreign Application Priority Data
Nov. 29, 2023 (JP) 2023-201564

(51) Int. Cl. G06N 20/20; G06V 20/30

(52) U.S. Cl. CPC G06N 20/20; G06V 20/30

(57) ABSTRACT

A server apparatus includes a request acquiring means, an answer acquiring means, and an answer providing means. The request acquiring means acquires a request related to a specific theme from a user, which is a first request to at least two or more learning models. The answer acquiring means acquires answers from each of the at least two or more learning models by using at least a scene showing a situation related to the specific theme and the first request. The answer providing means provides the answers acquired from each of the at least two or more learning models to the user.

### INCORPORATION BY REFERENCE

This application is based upon and claims the benefit of priority from Japanese Patent Application No. 2023-201564, filed on Nov. 29, 2023, the disclosure of which is incorporated herein in its entirety by reference.

### TECHNICAL FIELD

The present invention relates to a server apparatus, a control method of a server apparatus, and a non-transitory computer-readable storage medium.

### BACKGROUND ART

There are technologies that support communication between users.

For example, Patent Literature 1 (JP2017-220077 A) describes that a method of providing information is provided to enable smooth and good communication by appropriately speaking or appropriately receiving words based on an understanding of how one's own personality and preferences differ from those of the other party.

In Patent Literature 1, a tendency of a part of human personality and preferences that is involved in communication is clearly defined starting from the date of birth. It also clearly defines the tendency for problems to occur in communication between people with different personalities and how to deal with them. The method of providing information in Patent Literature 1 allows a user to enter the date of birth, date of execution, and information on the scene of the other party into a database of these information, so that the words can be spoken to the other party in a way that resonates with the other party, depending on the scene.

As described in paragraph of Patent Literature 1, there is a service that sets an artificial intelligence (a learning model acquired through machine learning) as a conversation partner to consult with a user about his or her concerns, and the like.

Here, since the artificial intelligence (learning model) outputs an answer in accordance with a question entered by the user, in the case where the question of the user is ambiguous, there is a possibility that the artificial intelligence will output an answer that the user does not intend. However, it is a great burden for the user to accurately enter his or her own concerns, and the like, in order to elicit an appropriate response from the learning model.

### SUMMARY

It is a main object of the present invention to provide a server apparatus, a control method of a server apparatus, and a non-transitory computer-readable storage medium storing a program that contribute to reducing burden on users who use a service provided by using learning models.

According to a first aspect of the present invention, there is provided a server apparatus, including: a request acquiring means that acquires a request related to a specific theme from a user, which is a first request to at least two or more learning models; an answer acquiring means that acquires answers from each of the at least two or more learning models by using at least a scene showing a situation related to the specific theme and the first request; and an answer providing means that provides the answers acquired from each of the at least two or more learning models to the user.

According to a second aspect of the present invention, there is provided a control method of a server apparatus, the control method including: a request acquiring step that acquires a request related to a specific theme from a user, which is a first request to at least two or more learning models; an answer acquiring step that acquires answers from each of the at least two or more learning models by using at least a scene showing a situation related to the specific theme and the first request; and an answer providing step that provides the answers acquired from each of the at least two or more learning models to the user.

According to a third aspect of the present invention, there is provided a non-transitory computer-readable storage medium storing a program causing a computer mounted on a server apparatus to perform processing for: a request acquiring processing that acquires a request related to a specific theme from a user, which is a first request to at least two or more learning models; an answer acquiring processing that acquires answers from each of the at least two or more learning models by using at least a scene showing a situation related to the specific theme and the first request; and an answer providing processing that provides the answers acquired from each of the at least two or more learning models to the user.

### BRIEF DESCRIPTION OF THE DRAWINGS

Exemplary features and advantages of the present invention will become apparent from the following detailed description when taken with the accompanying drawings in which:

FIG. 1 is a diagram illustrating an outline of an example embodiment;

FIG. 2 is a flowchart illustrating an operation of an example embodiment;

FIG. 3 is a diagram illustrating an example of a schematic configuration of an information processing system according to an example embodiment of the present disclosure;

FIG. 4 is a diagram illustrating an operation of the information processing system according to the example embodiment of the present disclosure;

FIG. 5 is a diagram illustrating an example of a display of a terminal according to the example embodiment of the present disclosure;

FIGS. 6A and 6B are diagrams illustrating an example of a display of a business operator terminal according to the example embodiment of the present disclosure;

FIG. 7 is a diagram illustrating an operation of the information processing system according to the example embodiment of the present disclosure;

FIGS. 8A and 8B are diagrams illustrating an example of a display of the business operator terminal according to the example embodiment of the present disclosure;

FIG. 9 is a diagram illustrating an operation of the information processing system according to the example embodiment of the present disclosure;

FIG. 10 is a diagram illustrating an example of a processing configuration of a server apparatus according to the example embodiment of the present disclosure;

FIG. 11 is a diagram illustrating an example of a learning model management database according to the example embodiment of the present disclosure;

FIG. 12 is a diagram illustrating an example of a scene management database according to the example embodiment of the present disclosure;

FIG. 13 is a diagram illustrating an example of a user management database according to the example embodiment of the present disclosure;

FIG. 14 is a diagram illustrating an example of a display of the terminal according to an example embodiment of the present disclosure;

FIG. 15 is a diagram illustrating an example of a display of the terminal according to an example embodiment of the present disclosure;

FIG. 16 is a flowchart illustrating an example of an operation of a service control unit according to the example embodiment of the present disclosure;

FIG. 17 is a flowchart illustrating an example of an operation of the service control unit according to the example embodiment of the present disclosure;

FIG. 18 is a flowchart illustrating an example of an operation of the service control unit according to the example embodiment of the present disclosure;

FIG. 19 is a diagram illustrating an example of a scene and the like selection history according to a variation of the example embodiment of the present disclosure;

FIG. 20 is a diagram illustrating an example of a conversation history according to the variation of the example embodiment of the present disclosure;

FIG. 21 is a diagram illustrating an example of a processing configuration of the server apparatus according to the example embodiment of the present disclosure;

FIG. 22 is a diagram illustrating an example of a display of the terminal according to the example embodiment of the present disclosure;

FIG. 23 is a flowchart illustrating an example of an operation of a user support unit according to the example embodiment of the present disclosure;

FIG. 24 is a diagram illustrating an operation of the information processing system according to the variation of the example embodiment of the present disclosure; and

FIG. 25 is a diagram illustrating an example of a hardware configuration of the server apparatus according to the present application.

### EXAMPLE EMBODIMENT

First, an outline of an example embodiment will be described. In the following outline, various components are denoted by reference characters for the sake of convenience. That is, the following reference characters are used as examples to facilitate the understanding of the present invention. Thus, the description of the outline is not intended to impose any limitations. In addition, unless otherwise specified, an individual block illustrated in the drawings represents a configuration of a functional unit, not a hardware unit. An individual connection line between blocks in the drawings signifies both one-way and two-way directions. An arrow schematically illustrates a principal signal (data) flow and does not exclude bidirectionality. In the present description and drawings, elements that can be described in a like way will be denoted by a like reference character, and redundant description thereof will be omitted as needed.

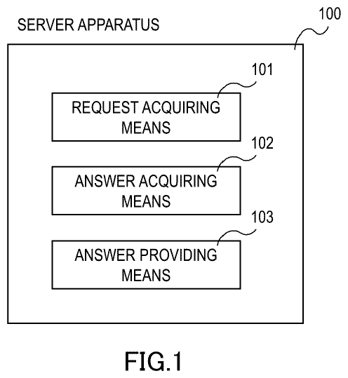

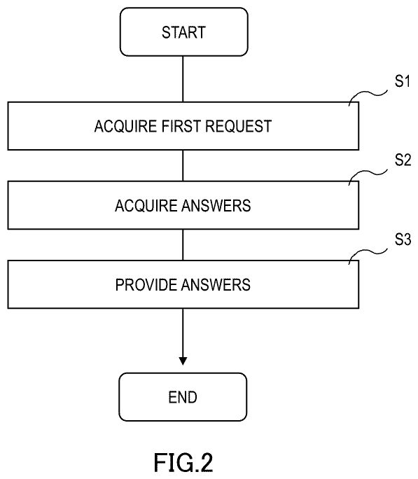

A server apparatus 100 according to an example embodiment includes a request acquiring means 101, an answer acquiring means 102, and an answer providing means 103 (see FIG. 1). The request acquiring means 101 acquires a request related to a specific theme from a user, which is a first request to at least two or more learning models (step S1 in FIG. 2). The answer acquiring means 102 acquires answers from each of the at least two or more learning models by using at least a scene showing a situation related to the specific theme and the first request (step S2). The answer providing means 103 provides the answers acquired from each of the at least two or more learning models to the user (step S3).

For example, the server apparatus 10 provides a service that accepts a question from the user and provides the service in which the learning model answers the question. At that time, the server apparatus 100 generates a query to be input to the learning models based on the scene indicating a situation, and so on, in which the user wants to ask the learning models a question (an answer request to the learning models) and the request. That is, the server apparatus 100 generates the query to be input into the learning models so that the answers from the learning models do not deviate significantly from the question from the user. For example, by selecting the scene related to the matter that the user wants to ask the learning models, the user can acquire an appropriate answer from the learning models without having to enter detailed background, circumstances, and so on related to his or her question. In other words, burden on the user who uses the service provided by using the learning models is reduced.

Hereinafter, specific example embodiments will be described in more detail with reference to drawings.

### First Example Embodiment

A first example embodiment will be described in more detail with reference to drawings.

### [System Configuration]

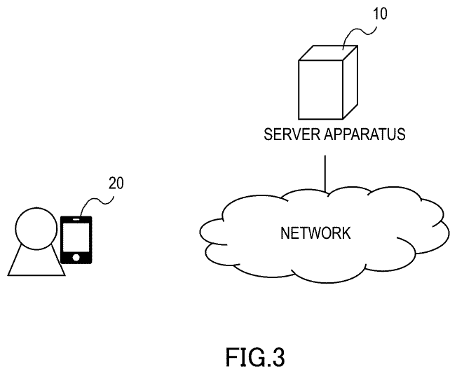

As shown in FIG. 3, an information processing system according to the first example embodiment includes a server apparatus 10.

The server apparatus 10 is operated by a business operator (service provider) that provides such a service that provides advice in response to a doubt or a question of a user on a specific theme. In the first example embodiment, a case in which the server apparatus 10 provides a support service related to child rearing will be described as an example.

The server apparatus 10 is a server that realizes the main tasks of a service provider that provides a child-rearing support service. The server apparatus 10 may be installed in a building of the service provider or on a network (on a cloud).

A user possesses a terminal 20. The user operates the terminal 20 to enter various pieces of information to the server apparatus 10, and so on, or acquire various pieces of information from the server apparatus 10, and so on.

The apparatuses illustrated in FIG. 3 are connected to each other. Specifically, the server apparatus 10 and the terminal 20 are connected by wired or wireless communication means and are configured to be able to communicate with each other.

The configuration of the information processing system shown in FIG. 3 is an example and is not intended to limit the configuration of the authentication system. For example, the information processing system may include a plurality of the server apparatuses 10. Load balancing and redundancy may be achieved by the plurality of server apparatuses 10.

### [Outline of Operation]

Next, a schematic operation of the information processing system according to the first example embodiment will be described.

### <Preparing Learning Model>

The server apparatus 10 provides a child-rearing support service using AI (Artificial Intelligence) models (learning models) acquired by machine learning. The service provider (an employee of the service provider, or the like) prepares learning models to be used for the child-rearing support service.

The service provider prepares a plurality of learning models, each of which provides a different answer (output) to a question (input). By appropriately selecting learning data used to generate the learning models, the service provider gives the answer of each learning model a characteristic (individuality).

For example, the service provider uses statements by a child-rearing expert (statements by an expert in a TV program, and so on) as learning data (text data) to generate the learning model that outputs an answer that reflects a way of thinking, and so on, of the expert.

Alternatively, the service provider uses learning data acquired from a book, or the like, by a scholar (for example, a university professor) on early childhood education, or the like, to generate the learning model that outputs an answer that reflects the way of thinking, and so on, of the scholar.

Alternatively, the service provider uses learning data such as statements made on the Internet by a person with child-rearing experience to generate the learning model that outputs an answer that reflects the experience and the way of thinking, and so on of the person with child-rearing experience. Note that the learning data on the person with child-rearing experience is collected from web logs (so-called blogs), SNS (Social Networking Service), and so on.

Note that the service provider prepares each of the above plurality of learning models as a large language model (LLM; Large Language Model).

### <Definition of Scene>

The service provider defines a situation related to a specific theme as a “scene”. In the first example embodiment, various situations that may arise during child-rearing are defined as “scenes”. In other words, the service provider defines in advance as “scenes” the situations and circumstances that many child-rearing persons are likely to experience.

The scene refers to an environment that is set up to simulate (pseudo reproduce) a situation of child-rearing in daily life. The scene defined by the service provider has a specific purpose or theme, and all or part of the scene reflects an actual concern related to child-rearing or the like that the child-rearing person is likely to encounter.

By appropriately defining the scene, the information processing system can provide a user with a framework for sharing the concern related to child-rearing among child-rearing persons and finding a solution.

For example, “putting a child to sleep” is given as a specific example of the scene. In the scene of putting a child to sleep, a situation in which a child-rearing person puts a child to sleep is simulated. Alternatively, “meal management” is given as a specific example of the scene. In the scene of meal management, a situation related to a meal of a child is simulated.

Once the plurality of learning models (the plurality of learning models characterized by learning data) are implemented in the server apparatus 10 and the scene is defined by the service provider, the server apparatus 10 becomes capable of providing the child-rearing support service.

### <Generation of Account>

A user (for example, a child-rearing person) generates an account with a service provider to receive a child-rearing support service. Specifically, the user operates the terminal 20 to access the server apparatus 10. The user enters login information (ID, password), name, gender, date of birth, address, telephone number, e-mail address, and so on, into a user registration site provided by the server apparatus 10.

After the server apparatus 10 acquires the name and so on of the user, the server apparatus 10 generates a user ID to identify the user. The server apparatus 10 stores the user ID, login information, name, date of birth, and so on in association with each other. The server apparatus 10 stores the user ID, login information, name, biometric information, and so on in a user information database. Details of the user management database will be described below.

By generating the account with the service provider, the user can receive the child-rearing support service from the service provider.

### <Starting to Use Child-Rearing Support Service>

A user who wishes to use a child-rearing support service logs in to his or her account. At first, the user who wishes to use the child-rearing support service selects a scene that corresponds to a concern, and so on, that the user is having. For example, the server apparatus 10 uses a GUI (Graphical User Interface) or the like to acquire the scene corresponding to the concern, and so on, that the user wishes to solve.

Once the user selects the scene, the user selects learning models to answer a question related to his or her concern, and so on. For example, the server apparatus 10 performs display of a list of each learning model characterized by learning data to realize the selection of the learning models by the user.

At that time, the user selects at least two or more learning models from the plurality of learning models implemented in the server apparatus 10.

For example, the user selects two or more learning models from among a learning model reflecting the ideas, and so on of a child-rearing expert (expert model), a learning model reflecting the ideas, and so on of a scholar of early childhood education (scholar model), and a learning model reflecting the ideas, and so on of a person with child-rearing experience (experienced person model).

After the user selects the scene and learning models, the user initiates a conversation related to the selected scene by targeting two or more of the above selected learning models.

<Conversation with Learning Model>

At first, the user operates the terminal 20 to enter the concern, and so on, that the user wishes to solve into the server apparatus 10. The server apparatus 10 outputs an answer to the concern of the user. The user requests an answer from the server apparatus 10 until the user feels that his or her concern, and so on, has been resolved.

The server apparatus 10 includes a basic function, an intervention function, and a flip function, and so on as functions to realize the above child-rearing support service. The server apparatus 10 realizes these functions using the plurality of learning models selected by the user.

### <Basic Function>

At first, the basic function will be described.

The basic function is a function that presents answers from the plurality of learning models in response to a question (answer request) from a user, in order. In the basic function, the second and subsequent learning models answer while referring to the answers from each learning model that has answered up to that point.

The request (the question from the user) and the answer (a response from the learning model) in the basic function are described as a first request and a first answer, respectively. For the one first request, the first answer is acquired from each of the plurality of learning models. A plurality of the first answers can be different from each other.

Note that a first answer to the first request (a first answer of learning model) will be denoted as a first request [1]. Similarly, a second answer to the first request will be denoted as a first request [2], and a third answer will be denoted as a first answer [3]. The first answer from a kth learning model will be denoted as a first answer [k] (k is a positive integer, the same applies hereafter).

Furthermore, a plurality of the first answers will be grouped together and denoted as a set of the first answers.

The server apparatus 10 acquires a first request from a user. The server apparatus 10 inputs the acquired first request to one of the plurality of learning models selected by the user.

Specifically, the server apparatus 10 selects one learning model from the plurality of learning models selected by the user. Furthermore, the server apparatus 10 generates a query based on the first request and a scene selected by the user so that an answer is provided in accordance with the scene selected by the user. The server apparatus 10 inputs the generated query into the one learning model selected above.

For example, in the case where the user selects three models: the expert model, the scholar model, and the experienced person model, the server apparatus 10 selects the expert model from among the three learning models. The server apparatus 10 inputs the query to the selected expert model.

After the server apparatus 10 acquires output data (first answer [1]) from the learning model, the server apparatus 10 selects one learning model from among the above plurality of learning models selected by the user and for which the query has not been input. For example, in the above example, the scholar model is selected from the scholar model and the experienced person model.

The server apparatus 10 generates a query to be input to the above second selected learning model based on the first request, the scene selected by the user, and the output data (first answer) of the learning model that has already answered. In the above example, the query to be entered into the scholar model (query for the scholar model) is generated in accordance with the first request, the scene, and a first answer [1] of the expert model.

The server apparatus 10 inputs the generated query into the second selected learning model to acquire the output data (a first answer [2]). In the above example, the server apparatus 10 acquires the first answer [2] from the scholar model.

Once the server apparatus 10 acquires the first answer [2] from a second learning model, the server apparatus 10 selects a third learning model to acquire an answer. In the above example, the experienced person model is selected.

Once the server apparatus 10 selects the third learning model, the server apparatus 10 generates a query for the third learning model based on the first request, the scene, and the output data (the first answer [1] and the first answer [2]) of the learning models that have already answered, as in the case of the second learning model described above. The server apparatus 10 uses the generated query to acquire a first answer [3] from the third learning model. In the above example, the server apparatus 10 acquires the first answer [3] from the experienced person model.

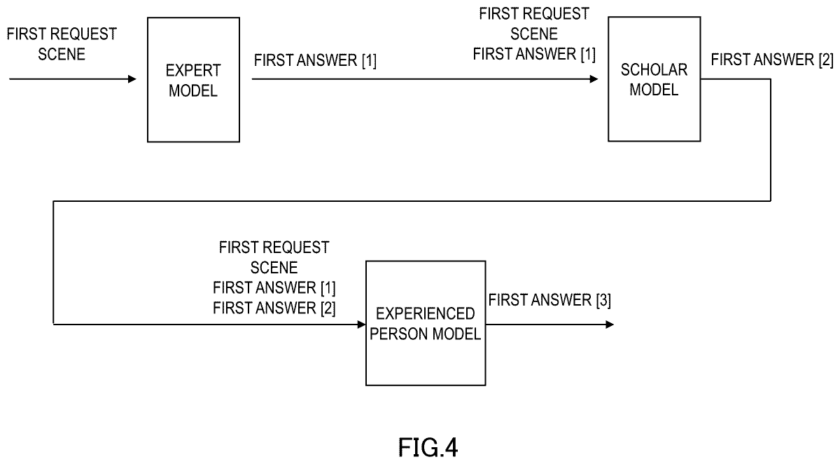

The inputs and outputs related to the above three learning models can be summarized as shown in FIG. 4. As shown in FIG. 4, the server apparatus 10 adds the question (answer request) of the user and the scene to the answer (output data) of the learning model that has already answered, and then inputs the question (answer request) of the user and the scene to a learning model at the latter stage, thereby acquiring an answer of the learning model that refers to the answer of the earlier learning model.

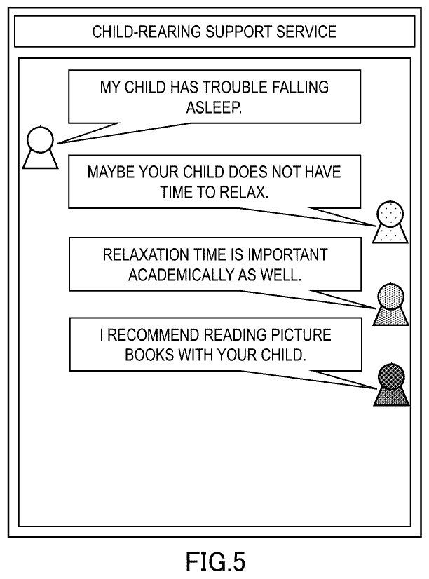

Once the server apparatus 10 acquires the first answers [1] to [3] from each learning model selected by the user in response to the first request of the user, the server apparatus 10 displays a first answer (a set of first answers) of each learning model on the terminal 20 (see FIG. 5).

Note that FIG. 5 illustrates an example of the first request and the first answers in the case where the user selects a “scene of putting a child to sleep” and selects the expert model, the scholar model, and the experienced person model.

Moreover, in the drawings that include FIG. 5, the person (icon) on the left side indicates the user (questioner). In addition, the persons (icons) on the right side indicate the learning models (respondents). Furthermore, the server apparatus 10 changes the color, and so on of the icon corresponding to each learning model so that the user can easily identify the respondents. For example, in FIG. 5, the icons on the right side correspond to the expert model, scholar model, and experienced person model, respectively, from top to bottom.

The user who believes that his or her concern, and so on, has been resolved by the first answer (the set of first answers) from each learning model terminates the child-rearing support service.

Here, the “intervention function” and the “flip function” are functions that meet the needs of a user who wishes to receive more answers and answers with more in-depth content.

### <Intervention Function>

The intervention function is a function to acquire new answers from the plurality of learning models in sequence by adding (intervening) a question by the user to the first answer (set of first answers) acquired by the basic function. The intervention function is a function that answers an additional question by the user.

In the intervention function, the new answer is acquired from the second and subsequent learning models by referring to the new answers of each learning model that have been acquired up to that point.

The request and the new answer that are added in the intervention function will be denoted as a second request and a second answer. For one second request, the second answer is acquired from each of the plurality of learning models. A plurality of the second answers are grouped together and will be denoted as a set of second answers.

Note that the intervention function may be further performed on the second and subsequent answers. New request and new answer in the intervention function performed on a nth answer will be denoted as an n+1 request and n+1 answer, and a plurality of n+1 answers are grouped together and will be denoted as a set of n+1 answers.

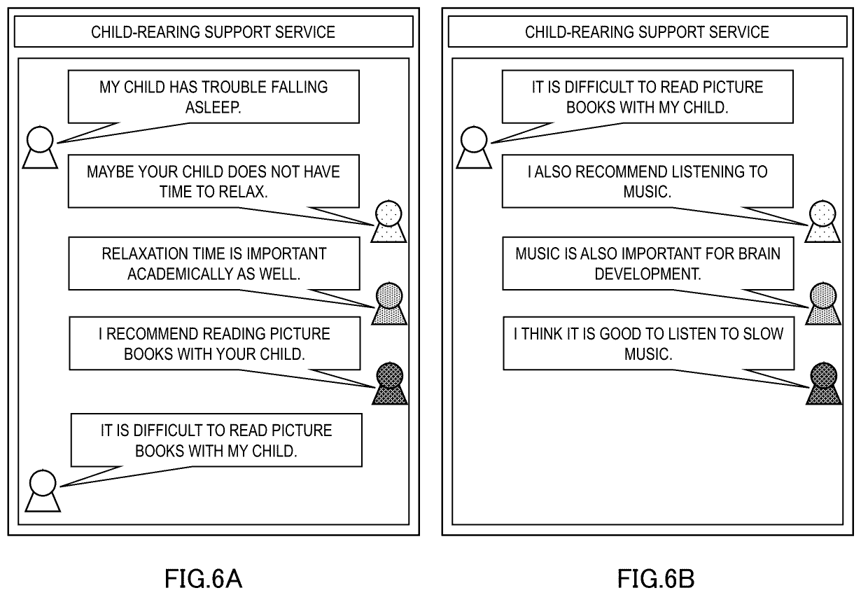

For example, in the state shown in FIG. 5 (the state where the set of first answers is displayed), the user enters an additional question (second request) to the server apparatus 10 (see FIG. 6A).

Once the server apparatus 10 acquires the additional question (second request) from the user, the server apparatus 10 generates a query from the second request of the user, the scene selected by the user, the first request and/or the set of first answers. The server apparatus 10 inputs the generated query into one of the plurality of learning models selected by the user.

For example, the server apparatus 10 inputs the generated query to the first selected learning model in the basic function (in the above example, the expert model). The server apparatus 10 acquires a second answer [1] from the learning model.

The server apparatus 10 generates a query to be input to the second selected learning model, similar to the basic function. The server apparatus 10 generates the query based on the second request, the scene, the first request and/or the set of first answers, and the second answer [1] of the learning model selected first. The server apparatus 10 inputs the generated query into the second learning model (the scholar model in the above example).

The server apparatus 10 performs similar processing for the third learning model (experienced person model).

Once the server apparatus 10 acquires the second answer (set of second answers) to the second question of the user from each learning model selected by the user, the server apparatus 10 displays the second answer on the terminal 20 (see FIG. 6B).

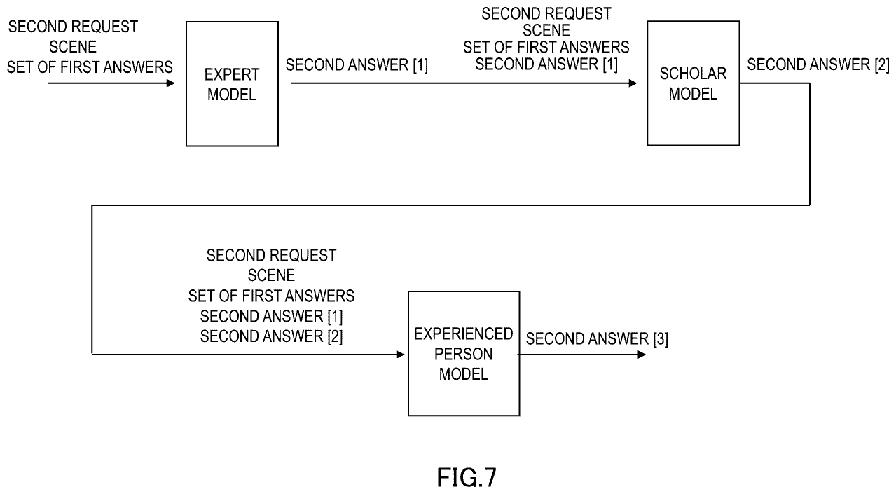

The inputs and outputs for the three learning models in the intervention function can be summarized as shown in FIG. 7. Note that in FIG. 7, the set of first answers acquired by the basic function is used to generate each query.

In this way, the user can repeatedly ask questions to the server apparatus 10 (the learning model selected by the user) using the intervention function.

### <Flip Function>

The flip function allows a user to change (flip) an order in which the plurality of learning models are used in response to the answer acquired by the basic function.

In the flip function, for at least one learning model, a new first answer that refers to the first answer already acquired is acquired from each learning model that is earlier the order after the change than the at least one learning model.

Here, the order of the learning models after being changed by the flip function will be denoted as k(new). For example, the server apparatus 10 makes one learning model [k(new)] refer to a first answer [1] to [k(new)−1] acquired from each learning model [1] to [k(new)−1] whose order after the change is earlier than that of the learning model [k(new)]. As a result, the server apparatus 10 acquires a new first answer [k(new)] corresponding to the first request from the learning model [k(new)]. Note that server apparatus 10 may acquire a new nth answer based on an order change instruction for a set of nth answers.

For example, a user who has reviewed answers from each of the learning models shown in FIG. 5 wishes to know more in-depth details about the answer of the expert model. Specifically, the user wishes to know the answer of the expert model that takes into account the answers of the other learning models (scholar model and experienced person model) to his or her question.

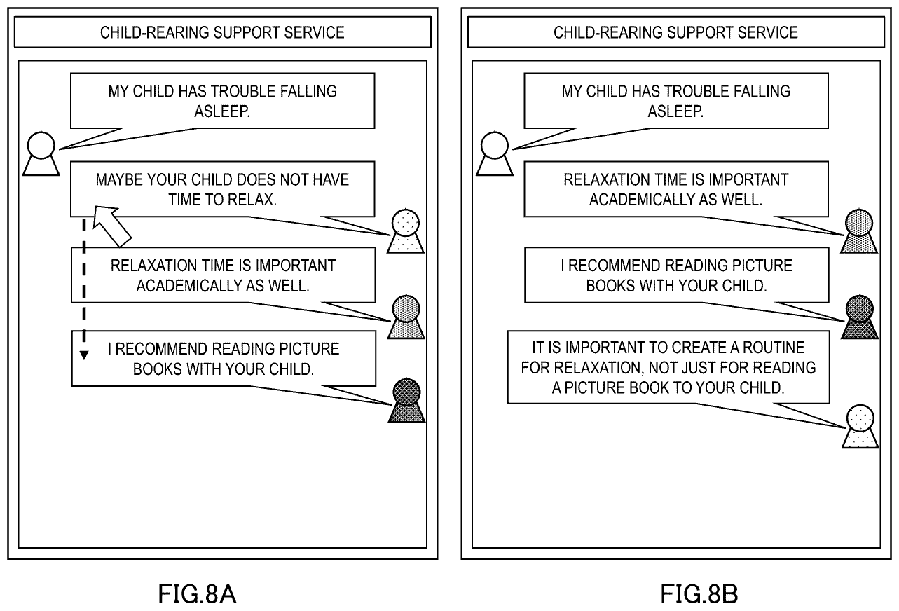

In this case, the user provides an “order change instruction” to the server apparatus 10 so that the expert model answers last. Details of a specific operation of the order change instruction will be described below and as shown in FIG. 8A, the user performs an operation such that a first answer [1] of the expert model is moved to a first answer [3] of the last experienced person model.

Once the server apparatus 10 receives the order change instruction, the server apparatus 10 generates a query for the user to enter the learning model whose order has been changed. Specifically, the server apparatus 10 generates the query based on the first request, the scene, the first answer [2] of the learning model that has answered already, and the first answer [3] that has answered already.

The server apparatus 10 inputs the generated query into the learning model whose order has been changed by the user. As described above, in the case where the expert model is changed to answer last, the server apparatus 10 acquires a first answer [3(new)] from the expert model. The server apparatus 10 displays the acquired first answer [3(new)] on the terminal 20 (see FIG. 8B).

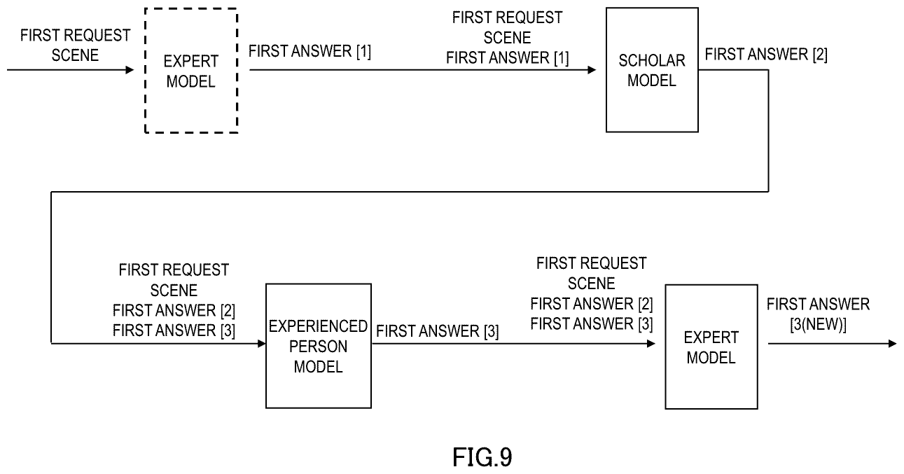

The inputs and outputs related to the three learning models in the flip function can be summarized as shown in FIG. 9. As shown in FIG. 9, the expert model selected by server apparatus 10 as the learning model to answer first in the basic function has been changed in its order so that the expert model becomes the learning model to answer last by the user. In other words, the order in which the expert model, the scholar model, and the experienced person model answer is changed to the order in which the scholar model, the experienced person model, and the expert model answer by the user utilizing the flip function.

Next, details of the individual apparatuses included in the information processing system according to the first example embodiment will be described.

### [Server Apparatus]

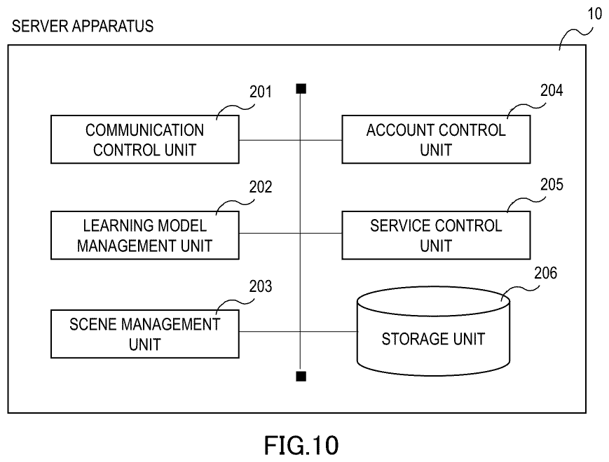

FIG. 10 is a diagram illustrating an example of a processing configuration (processing module) of the server apparatus 10 according to an example embodiment of the present application. Referring to FIG. 10, the server apparatus 10 includes a communication control unit 201, a learning model management unit 202, a scene management unit 203, an account control unit 204, a service control unit 205, and a storage unit 206.

The communication control unit 201 is means for controlling communication with other apparatuses. For example, the communication control unit 201 receives data (packets) from the terminal 20. In addition, the communication control unit 201 transmits data to the terminal 20. The communication control unit 201 gives data received from other apparatuses to other processing modules. The communication control unit 201 transmits data acquired from other processing modules to other apparatuses. In this way, other processing modules transmit and receive data to and from other apparatuses via the communication control unit 201. The communication control unit 201 includes a function as a receiving unit that receives data from other apparatuses and a function as a transmitting unit that transmits data to other apparatuses.

The learning model management unit 202 is means for performing control and management related to the learning models.

The learning model management unit 202 acquires the plurality of learning models (plurality of learning models characterized by learning data) prepared by a system administrator or the like.

At that time, the learning model management unit 202 acquires, for each learning model, the model name, features, and information related to the learning data used to generate the learning model, and so on, from the system administrator or the like. For example, the learning model management unit 202 acquires information on each learning model using a GUI or the like. Alternatively, the learning model management unit 202 may acquire information on each learning model via a USB (Universal Serial Bus) memory or the like.

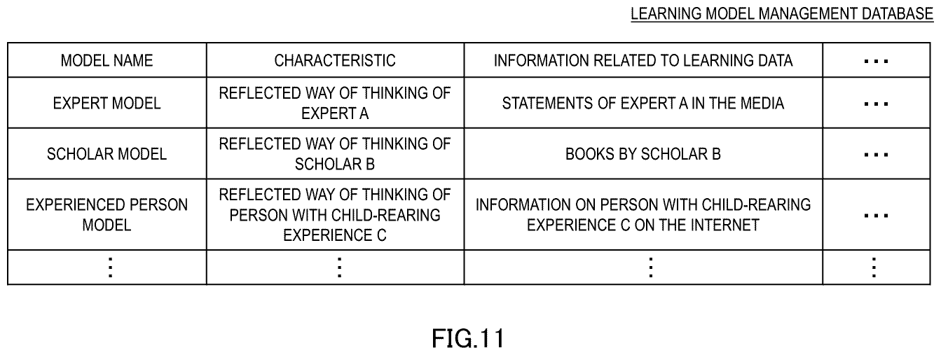

The learning model management unit 202 stores the acquired information on the learning model in a learning model management database (see FIG. 11). Note that the learning model management database shown in FIG. 11 is an example and is not intended to limit the items to be stored.

For example, learning models specialized for a specific area (scene) of child rearing may be registered in the server apparatus 10.

For example, a bedtime support model specialized in “putting a child to sleep” may be generated and registered in the server apparatus 10. The bedtime support model provides detailed information (answers) related to techniques and routines for putting a child to sleep. Alternatively, a relaxation support model specialized in “relaxation” may be generated. Alternatively, a behavior analysis model specialized in behavior analysis related to putting a child to sleep may be generated. This relaxation support model provides detailed information on child's relaxation and mindfulness. The behavior analysis model is generated based on a behavior analysis related to behavior before a child goes to bed, and suggests an improvement related to putting the child to bed, and so on. Alternatively, a nighttime story creation model may be generated that is specialized in creating a story at the time of putting a child to bed. The nighttime story creation model provides a story and reading of the story at the time of putting a child to bed.

Next, an overview of the learning model and generation of the learning model will be provided.

The learning model is the model that generates an answer corresponding to a request. As an example, if a query generated based on a request, and so on from a user is input, the learning model outputs the answer corresponding to the query.

As an example, the learning model is composed of a language model. The language model may be, for example, what is referred to as LLM (Large Language Models), but is not limited to this.

The language model is a machine learning model (also called a generative model) that inputs language and outputs language. The language model learns the relationships between words in a sentence, and is the model that generates a related character string from a target character string that is related to the target character string. By using the language model that has learned sentences and phrases in various contexts, it is possible to generate the related character string with appropriate content that is related to the target character string.

For example, a case in which the language model is used in question answering will be described. The language model accepts an input question “What kind of country is Japan?” as a target character string. The language model generates a character string such as “Japan is an island country in the northern hemisphere.” as an answer to the question.

The learning method of the language model is not particularly limited, but as an example, the language model may be learned to output at least one sentence that includes the input character string. As a specific example, the language model is a GPT (Generative Pre-Transformer) that outputs a sentence including the input character string by predicting a character string that has a high probability of following the input character string.

Other examples of language models include, for example, T5 (Text-to-Text Transfer Transformer), BERT (Bidirectional Encoder Representations from Transformers), ROBERTa (Robustly optimized BERT approach), ELECTRA (Efficiently Learning an Encoder that Classifies Token Replacements Accurately), and so on.

Alternatively, the language model may output a natural language corresponding to a character string input in an artificial language. Moreover, the content generated by the language model is not limited to the character string. For example, the language model may generate image data, video data, audio data, or other data formats corresponding to the input character string.

The learning model (language model) is generated based on learning data. For example, in the case of generating a learning model that reflects the way of thinking of the expert, a variety of learning data (data resources) such as public statements by the expert in the media, and so on, relevant industry texts, reports, and so on, are utilized to train (learn) the learning model.

Alternatively, the learning model with specific characteristics may be generated by utilizing the existing learning model (language model). For example, transfer learning (fine tuning) may be performed, in which the weights of the learned model generated in advance are trained with new learning data. Specifically, the existing language model may be used, and an additional training may be performed using original learning data (dataset) to characterize the learning model. The learning model may be characterized (personalized) by preparing statements made by the expert, scholar, and person with child-rearing experience, respectively, as learning data, and then additionally making the base learning model learn from these learning data.

A “feedback” technique may be used to generate the learning model. For example, an evaluator (a generator of the learning model) or the like determines whether or not a feedback is appropriate for an output from the learning model. The results of the determination are used as learning data and re-learning is performed. As a result, performance (output accuracy) of the learning model is improved. For example, in the case of generating the learning model that reflects the idea of the expert (the expert model), the evaluator (the generator of the learning model) may provide a feedback so that the result of the output of the expert model “becomes closer to an answer of the specific expert”.

Note that, with regard to characterization (personalization) of the learning model, in addition to generating the learning model using the learning data, the learning model may be characterized by so-called “prompt engineering”. In other words, by devising a question or instruction (prompt) to be input into the learning model, the output of the learning model may be guided (regulated) in a specified manner. For example, in the case where one wishes to get an answer like that of the expert (in the case where one wishes to utilize the existing learning model as the expert model), one may enter a fixed sentence such as “Please think like expert A”, into the above learning model. Alternatively, a relevant statement, and so on, of the expert may be acquired from a database, and the statement acquired from the database may be input into the learning model together with the above fixed sentence.

The scene management unit 203 is a means of performing control and management related to a scene in the case of providing a child-rearing support service.

The scene management unit 203 acquires information related to a scene from a system administrator or the like. For example, the scene management unit 203 acquires information related to the scene using a GUI or the like. The scene management unit 203 acquires information such as a name of the scene, a description of the scene, and a purpose of the scene, and so on.

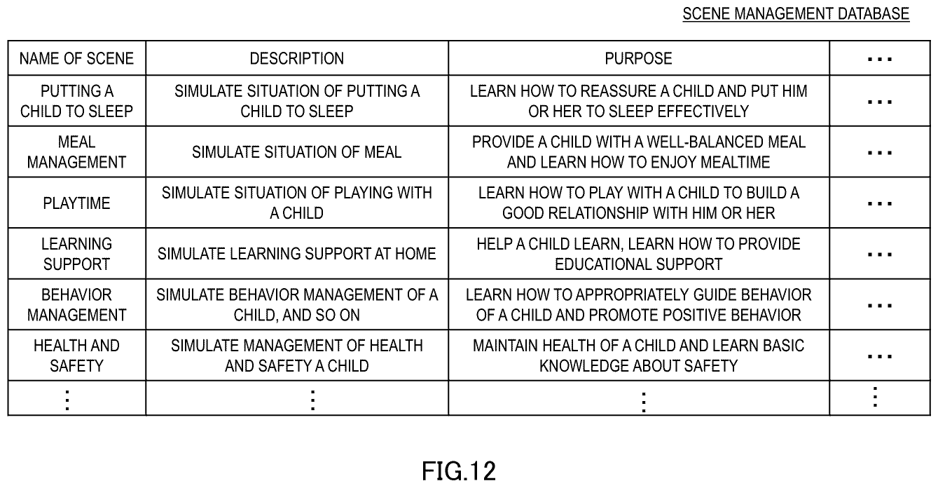

The scene management unit 203 stores the acquired information on the scene in a scene management database (see FIG. 12). Note that the scene management database shown in FIG. 12 is an example and is not intended to limit the items to be stored.

Note that a scene creator creates the scene (information related to the scene) in collaboration with a child-rearing expert or educator. The scene creator defines in advance a situation related to communication with a child that is important in daily life. For example, the scene creator defines a scene related to “putting a child to sleep,” a scene related to “meal management,” and so on, and enters related information into the server apparatus 10.

The account control unit 204 is means for performing control related to an account of a user.

The account control unit 204 acquires a login ID (ID and password), name, gender, address, date of birth, telephone number, e-mail address, and so on of the user at the user registration site.

After the account control unit 204 acquires the name and so on, the account control unit 204 generates a user ID to identify the user. The user ID may be any information that can uniquely identify the user. For example, the account control unit 204 may assign a unique value each time an account is created and use the unique value as the user ID.

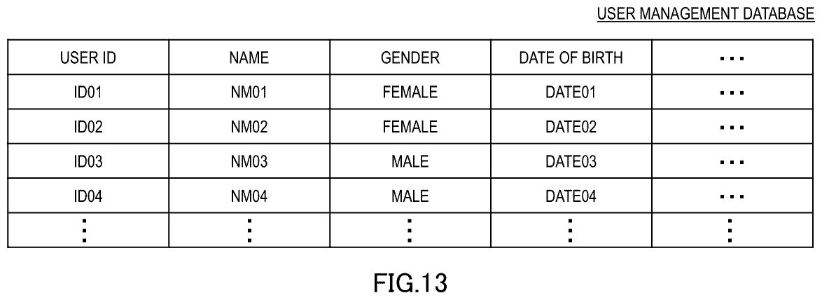

The account control unit 204 stores the name, gender, and so on in the user management database (see FIG. 13). Note that the user management database shown in FIG. 13 is an example, and is not meant to limit the items to be stored.

The account control unit 204 authenticates the user who logs into the account using login information.

The service control unit 205 is means for performing control related to a user support (child-rearing support) service.

The service control unit 205 includes a function as a request acquisition unit, a function as an answer acquisition unit, and a function as an answer providing unit.

The request acquisition unit acquires a first request to at least two or more learning models, which is the request from a user related to a specific theme (for example, child rearing). The answer acquisition unit acquires answers from each of the at least two or more learning models by using at least a scene showing a situation related to the specific theme (for example, the scene of putting a child to sleep) and the first request. The answer providing unit provides the answers acquired from each of the at least two or more learning models to the user.

The service control unit 205 includes a function as a scene selection control unit to acquire a scene selected by the user from among a plurality of scenes. Furthermore, the service control unit 205 includes a function as a learning model selection control unit to acquire at least two or more learning models selected by the user from among a plurality of learning models.

An operation of the above service control unit 205 will be described in detail below.

If a user who has logged in to an account wishes to be provided the child-rearing support service, the service control unit 205 acquires a scene in which the user wishes to consult (talk with AIs). For example, the service control unit 205 acquires the scene that the user desires by using a GUI or the like.

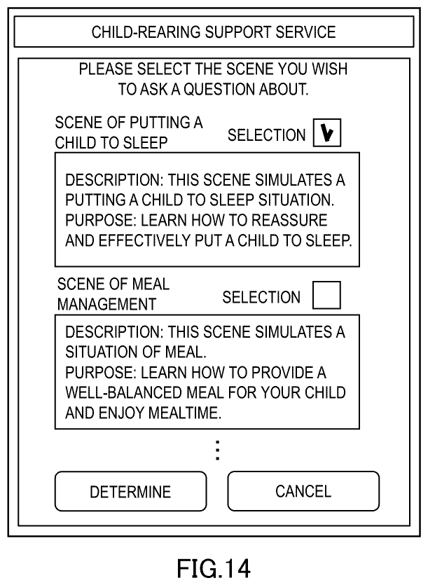

For example, the service control unit 205 displays a list of scenes stored in the scene management database and enables the user to select a scene (see FIG. 14).

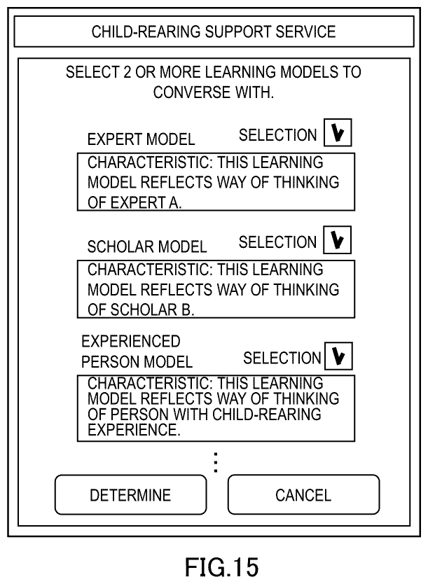

Once the service control unit 205 acquires the scene, the service control unit 205 acquires at least two or more learning models to be a conversation partner for the user. The service control unit 205 acquires a plurality of learning models by using a GUI or the like. The service control unit 205 displays a list of learning models stored in the learning model management database and enables the user to select learning models (see FIG. 15).

Once the service control unit 205 acquires the scene that the user desires and the plurality of learning models, the service control unit 205 acquires a question from the user (answer request; first request). Once the service control unit 205 acquires the first request, the service control unit 205 acquires a first answer of each learning model that the user has selected using the basic function.

Note that in the following description, the number of learning models selected by the user is denoted as “N” (N is an integer equal to or greater than 2, the same applies hereafter). For example, in the above example, N=3.

Moreover, each learning model selected by the user will be denoted as “learning model ML-N” using the above N. For example, in the above example, N=3, and each of learning model ML-1, learning model ML-2, and learning model ML-3 are learning models selected by the user. In the above example, the expert model corresponds to the learning model ML-1, the scholar model corresponds to the learning model ML-2, and the experienced person model corresponds to the learning model ML-3.

Furthermore, the order in which the learning model ML-N is used is determined in advance, at least in the basic function. In the following description, it is assumed that each learning model will answer in the following order: learning model ML-1 (expert model), learning model ML-2 (scholar model), and learning model ML-3 (experienced person model).

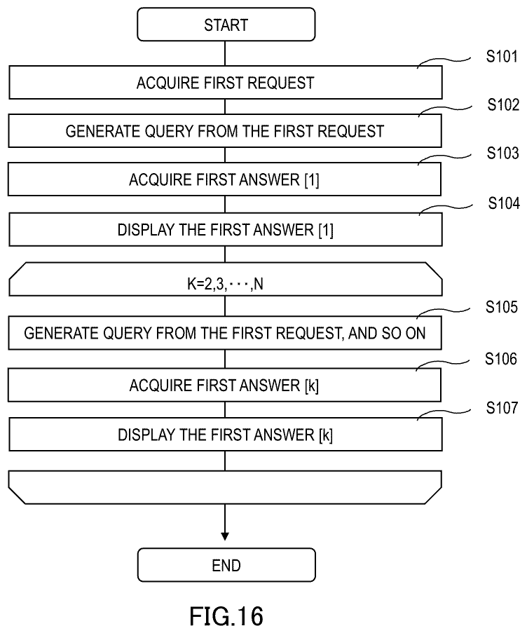

FIG. 16 is a diagram illustrating an example of an operation of the service control unit 205 according to an example embodiment of the present application. Referring to FIG. 16, an operation related to the basic function of the service control unit 205 will be described.

Step S101 is an example of an input acquiring processing. In step S101, the service control unit 205 acquires a first request input by a user to the terminal 20. For example, the service control unit 205 acquires the first request “My child has trouble falling asleep.” shown in FIG. 5.

Steps S102 and S103 in FIG. 16 are an example of at least a part of an answer acquisition processing. Steps S102 and S103 are the example of the processing for acquiring a first answer [1] from the first learning model ML-1.

In step S102, the service control unit 205 generates a query to be input to the first learning model ML-1 based on the first request and a scene selected by the user.

For example, the service control unit 205 may generate a query in a suitable format for the learning model ML-1 from the first request and the scene selected by the user. The suitable format is a format for acquiring an appropriate answer from the learning model ML-1. For example, the service control unit 205 may convert the first request and scene in accordance with a predetermined conversion rule as the query.

In addition, for example, the service control unit 205 may generate a query in the above suitable format by inputting the first request and scene into a query generation model (AI model for query generation; not shown) that is capable of generating the query in the format suitable for the learning model ML-1. The query generation model may be, but is not limited to, the language model.

Once the user selects a scene for putting a child to sleep, for example, a query “Scene of putting a child to sleep; The user is troubled by the fact that his or her child has trouble falling asleep.” may be generated, as the query to be input into the learning model ML-1, from the scene for putting a child to sleep and the first request “My child has trouble falling asleep.”

In step S103, the service control unit 205 inputs the generated query to the learning model ML-1 so that the service control unit 205 acquires a first answer [1] from the learning model ML-1.

In step S104, the service control unit 205 displays the acquired first answer [1] on the terminal 20. In the example in FIG. 5, the first answer on the right side of the screen area, “Maybe your child does not have time to relax.” is the first answer [1].

Next, steps S105 to S107 are performed for each of k=2, 3, . . . , N.

Steps S105-S107 are an example of a series of processing to acquire a first answer [k] from the second or subsequent learning model ML-k.

At first, the case where k=2, in which the first answer [2] is acquired, will be described.

In step S105, the service control unit 205 generates a query to be input to a second learning model ML-2 based on the first request, the scene and the first answer [1].

For example, the service control unit 205 may generate a query in a suitable format for the learning model ML-2 from the first request, the scene, and the first answer [1]. For example, the service control unit 205 may generate the query in the suitable format by inputting the first request, the scene, and the first answer [1] into the query generation model described above. A specific example of the query generation model has been described above, and therefore, a detailed description will not be repeated.

As an example, a query “Scene of putting a child to sleep; The user is troubled by the fact that his or her child has trouble falling asleep. The expert has pointed out that the child does not have time to relax.” may be generated from the first request “My child has trouble falling asleep.”, the scene of putting a child to sleep, and the first answer [1] “Maybe your child does not have time to relax.”

In step S106, the service control unit 205 inputs the above generated query to the learning model ML-2 to acquire the first answer [2] from the learning model ML-2.

In step S107, the service control unit 205 displays the acquired first answer [2] on the terminal 20. In the example in FIG. 5, the second answer on the right side of the screen area, “Relaxation time is important academically as well.” is the first answer [2].

The first answer [2] reflects the way of thinking, and so on of the scholar, and so on, which is the basis of the scholar model. The first answer [2] can be different from the first answer [1] that corresponds to the same first request.

In the example in FIG. 5, the first answer [2] of the scholar model includes the statement, “Relaxation time is important academically as well.” The first answer [2] is the answer of the scholar model corresponding to the first request “My child has trouble falling asleep.” and is generated by the learning model ML-2, which referred to the first answer [1] of the expert model “Maybe your child does not have time to relax.”

Next, the case where k=3, in which a first answer [3] is acquired, will be described.

In step S105, the service control unit 205 generates a query to be input to a third learning model ML-3 based on the first request, the scene, the first answer [1], and the first answer [2].

In addition, for example, the service control unit 205 may generate a query in a suitable format for the learning model ML-3 from the first request, the scene, the first answer [1], and the first answer [2]. For example, the service control unit 205 may generate the query in the suitable format by inputting the first request, the scene, and the first answer [1] and the first answer [2] into the above-mentioned query generation model.

As an example, a query “Scene of putting a child to sleep; The user is troubled by the fact that his or her child has trouble falling asleep. The expert has pointed out that the child does not have time to relax. The scholar has pointed out that relaxation time is important academically as well.” may be generated from the first request “My child has trouble falling asleep.”, the scene of putting a child to sleep, the first answer [1] “Maybe your child does not have time to relax.”, and the first answer [2] “Relaxation time is important academically as well.”

Steps S106 and S107 in the case of k=3 will be described in the same way by replacing [2] with [3] in the description for the case of k=2. As a result, the first answer [3] acquired in step S106 reflects the idea of the person with child-rearing experience, and may differ from the first answer [1] and the second answer [2] that correspond to the same first request.

In FIG. 5, the first answer [3] of the experienced person model includes “I recommend reading picture books with your child.” The first answer [3] is the answer of the experienced person model that corresponds to the first request “My child has trouble falling asleep.” and the first answer [3] is generated by the learning model ML-3 by referring to the first answer [1] and the first answer [2].

Thereafter, steps S105 to S107 are performed for each k while incrementing k by 1, and once these series of steps are completed for k=N, the basic function is completed.

Since these series of steps for cases where k=4 or greater are almost the same as for cases where k=2 or k=3, we will not repeat the detailed description. In the example in FIG. 5, since N=3, the first answer [1] to the first answer [3] are displayed, and the basic function is complete. The first answer [1] to the first answer [3] constitutes an example of the set of first answers.

In this way, the service control unit 205 generates a first query to be input to a first learning model among at least two or more learning models based on a scene and a first request. The service control unit 205 acquires a first answer from the first learning model by inputting the generated first query into the first learning model. The service control unit 205 generates a second query to be input to a second learning model among at least two or more learning models based on the scene, the first request and the first answer. The service control unit 205 acquires a second answer from the second learning model by inputting the generated second query into the second learning model. The service control unit 205 provides the first and second answers to the user.

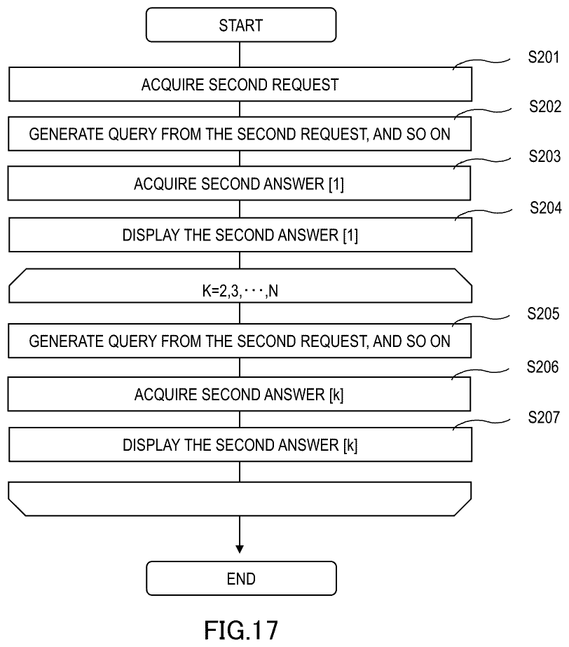

FIG. 17 is a diagram illustrating an example of an operation of the service control unit 205 according to an example embodiment of the present application. Referring to FIG. 17, an operation related to the intervention function of the service control unit 205 will be described.

The intervention function is performed following the basic function. For example, the intervention function is started in the state shown in FIG. 5. As shown in FIG. 17, the intervention function includes steps S201 to S207.

Steps S201 to S207 can be described in a similar way by replacing the first request in Steps S101 to S107 in FIG. 16 with the second request and the first answer with the second answer. However, there are the following differences.

In step S202, the service control unit 205 generates a query to be input to the first learning model ML-1 based not only on the second request, but also on one or both of the first request and the set of first answers acquired up to that point.

In addition, in step S205, the service control unit 205 generates a query to be input to the kth learning model ML-k based not only on the second request and the second answer [1] to [k-1], but also on one or both of the first request and the set of first answers.

For example, the bottom line of FIG. 6A includes the second request “It is difficult to read picture books with my child.” acquired in step S201.

Note that in the example in FIG. 6A, in step S202, in addition to the second request, a query is generated based on the first request, the scene, and the set of first answers. For example, a query,

“Scene of putting a child to sleep; The user is troubled by the fact that his or her child has trouble falling asleep, and it has been suggested that the user read picture books with his or her child, but it seems difficult for the user to read picture books with his or her child.” is generated.

FIG. 6B describes second answers of learning models ML-1 to ML-3, which take into account the second request of the user and the set of first answers acquired from the basic function.

Specifically, FIG. 6B includes the second answer [1] “I also recommend listening to music.” displayed in step S204. The second answer [1] is the answer of the expert model corresponding to the second request “It is difficult to read picture books with my child.”

In addition, FIG. 6B includes the second answer [2] “Music is also important for brain development.” displayed in step S207 (k=2). The second answer [2] is the answer of the scholar model that corresponds to the second request “It is difficult to read picture books with my child.” The second answer [2] is generated by the scholar model by referring to the second answer [1] of the expert model, which is “I also recommend listening to music.”

Furthermore, FIG. 6B includes the second answer [3] “I think it is good to listen to slow music.” that displayed in step S207 (k=3). The second answer [3] is the answer of the experienced person model that corresponds to the second request “It is difficult to read picture books with my child.” The second answer [3] is generated by the experienced person model by referring to the second answer [1] of the expert model and the second answer [2] of the scholar model.

In the example in FIG. 6B, since N=3, the second answer [1] to the second answer [3] are displayed, and the intervention function is completed. The second answer [1] to the second answer [3] constitutes an example of the set of second answers.

In this way, the service control unit 205 acquires a second request from a user to whom the first and second answers are provided. The service control unit 205 generates a third query to be input into the first learning model based on the scene, the second request, and the first and/or second answers. The service control unit 205 acquires a third answer (second answer [1]) from the first learning model by inputting the generated third query into the first learning model. The service control unit 205 generates a fourth query to be input to the second learning model based on the scene, the second request, the third answer (second answer [1]), and the first and/or second answers. The service control unit 205 acquires the fourth answer (second answer [2]) from the second learning model by inputting the generated fourth query into the second learning model.

As described above, the service control unit 205 acquires the second request entered by the user in response to the display of the set of first answers. The service control unit 205 uses each of the plurality of learning models in turn and acquires the second answer corresponding to the second request from each learning model. At that time, the service control unit 205 causes each of the second and subsequent learning models to refer to the second answer acquired from at least one learning model used before the each of the second and subsequent learning models. The service control unit 205 displays on the terminal 20 the set of second answers that includes the second answers acquired from each of the plurality of learning models.

As a result, the user can respond to and intervene in the answer obtained from the plurality of learning models and make the second request. In addition, the set of second answers is acquired from each learning model collectively in response to the intervention of the user. Moreover, as with the first answer, the second answer is generated by referring to the other second answer acquired up to that point from each of the other learning models. Therefore, comparing to the case of simply acquiring answers from the plurality of learning models collectively, it is possible to efficiently acquire a more useful set of second answers.

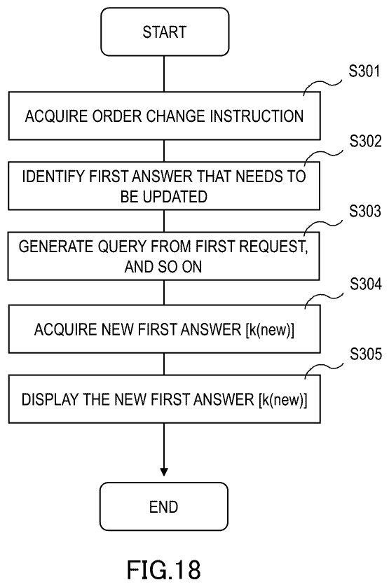

FIG. 18 is a diagram illustrating an example of an operation of the service control unit 205 according to an example embodiment of the present application. Referring to FIG. 18, an operation of the flip function of the service control unit 205 will be described.

The flip function is performed following the basic function or the intervention function. For example, the intervention function is started in the state shown in FIG. 5. As shown in FIG. 18, the flip function includes steps S301 to S305.

In step S301, the service control unit 205 acquires an order change instruction entered by the user in response to the display of the set of first answers. As mentioned above, the order change instruction represents an instruction to change the order in which the plurality of learning models are used.

For example, the user may drag the area of any first answer displayed on the terminal 20 to the area indicating the order after the change as an order change instruction.

In FIG. 5, the user wants to get the first answer from the expert model last. In other words, the user wants the expert model to provide an answer that refers to the first answers of the scholar model and the experienced person model.

In this case, as shown in FIG. 8A, the user drags the first answer [1] of the expert model over the first answer [3] of the experienced person model, which is the last one acquired at this time. By doing so, the order change instruction is input to change the order in which the plurality of learning models are used from the order of the expert model, the scholar model, and the experienced person model to the order of the scholar model, the experienced person model, and the expert model. Note that the operation for inputting the order change instruction is not limited to the above described example.

In step S302 of FIG. 18, the service control unit 205 identifies a first answer [k(new)] that needs to be updated by applying the order after the change. Here, each answer (first answer [1] to first answer [N]) may be identified as the first answer [k(new)] that needs to be updated. In this case, in other words, the basic function is repeated by applying the order after the change.

Furthermore, a part of the first answer [1] to the first answer [N] may be specified as the first answer [k(new)] that needs to be updated. For example, the first answer which the user has operated to provide the order change instruction may be identified as the first answer [k(new)] which needs to be updated. This is because, with regard to the first answer that was operated by the user, there is a high possibility that the user wants to know the new first answer to which the order after the change has been applied.

In addition, the user may be able to select whether the first answer [k(new)] that needs to be updated is all or part of the first answer [1] to the first answer [N]. Here, descriptions will continue under the assumption that the first answer operated by the user has been identified as the first answer [k(new)] that needs to be updated. In the example in FIG. 8A, the first answer of the expert model that was operated by the user is identified as the first answer [k(new)] that needs to be updated.

In step S303, the service control unit 205 generates a query based on the first request, the scene and the first answer [1(new)] to the first answer [k(new)−1]. The [1(new)] indicates that the order after the change is number 1. The first answer [1(new)] to the first answer [k(new)−1] may be included in the previous set of first answers.

For example, in the example in FIG. 8A, the order after the change of the expert model (learning model ML-1) is third, and k(new)=3. Moreover, the first answer [1(new)] is the first answer [2] that has already been acquired from the scholar model (learning model ML-2) whose order after the change is first. Furthermore, the first answer [k(new)−1]=the first answer [2(new)] is the first answer [3] that has already been acquired from the experienced person model (learning model ML-3) whose order after the change is second.

The service control unit 205 generates a query based on the first request, the scene, the first answer [2], and the first answer [3]. For example, a query “Scene of putting a child to sleep; The user is troubled by the fact that his or her child has trouble falling asleep. The scholar has pointed out that relaxation time is important academically as well. The experienced people has suggested that the user read picture books with his or her child.” is generated.

In step S304, the service control unit 205 inputs the generated query into a learning model ML[k(new)]. The service control unit 205 acquires the new first answer [k(new)] from the learning model ML[k(new)].

In step S305, the service control unit 205 displays the acquired first answer [k(new)] on the terminal 20. For example, the service control unit 205 may display a new first answer [k(new)] on the terminal 20 in addition to the set of first answers already displayed.

Moreover, the service control unit 205 may replace the first answer [k] with the new first answer [k(new)] in the already displayed set of first answers. In this case, the service control unit 205 may rearrange the order of display of the first answer [1(new)] through the first answer [k(new)] that includes the updated new first answer [k (new)] in the already displayed set of first answers in accordance with the order after the change.

An example of the new first answer [k(new)] displayed on the terminal 20 will be described with reference to FIG. 8B.

FIG. 8B differs from FIG. 8A in that instead of the first answer [1], FIG. 8B includes a first answer [3(new)], “It is important to create a routine for relaxation, not just for reading picture books to your child”

The first answer [3(new)] is the answer from the expert model corresponding to the first request, “My child has trouble falling asleep.” and is an updated version of the first answer [1] of the initial expert model. The first answer [3(new)] is generated by referring to the first answer [2] of the scholar model and the first answer [3] of the experienced person model, which could not be referred to before the order has been changed.

Furthermore, in FIG. 8B, the order of display of the first answer [2] of the scholar model, the first answer [3] of the experienced person model, and the first answer [3(new)] of the expert model has been rearranged in accordance with the order after the change.

In the example in FIGS. 8A and 8B, the user can change the order in which the expert model is used to a later order (for example, the last order) if the user is interested in the idea of the expert. This allows the user to acquire a more useful first answer [3(new)] of the expert model that refers to the first answer [2] and first answer [3] of others instead of the first answer [1] of the expert model that had not previously referred to the first answer [2] and the first answer [3] of others.

Note that the user may provide an order change instruction not only to change the order of the learning models that he or she is interested in to a later order, as shown in FIG. 8A, but also to change the order of the learning that model he or she is not interested in to an earlier order.

In this way, the service control unit 205 acquires an instruction (order change instruction) indicating to change the order of answers of the first and second learning models from the user to whom the first and second answers have been provided. The service control unit 205 generates a third query to be input to the first learning model based on the scene, the first request, and the second answer (the answer of the second model before the order is changed). The service control unit 205 acquires the third answer (the answer of the first learning model after the order is changed) from the first learning model by inputting the generated third query into the first learning model.

As described above, the service control unit 205 acquires an instruction to change the order in which the plurality of learning models are used, which is a question (request) entered by the user in response to the display of the set of first answers. The service control unit 205 causes at least one of the plurality of learning models to refer to the first answer acquired from each learning model whose order after the change is earlier than that of the at least one learning model. As a result, the service control unit 205 acquires the new first answer corresponding to the first request from the at least one learning model. The service control unit 205 displays the new first answer acquired from the learning model on the terminal 20.

In this way, the user can change the order in which each learning model is used. As a result, the user can acquire a new, more useful first answer from the learning model he or she is interested in. For example, the user can make the learning model that he or she is interested in refer to the first answers of more other learning models by changing the order of the learning models that he or she is interested in to a later order (for example, the last order). As a result, the user can efficiently acquire more useful first answer from the learning model that he or she is interested in.

The storage unit 206 is means for storing information necessary for an operation of the server apparatus 10. The storage unit 206 stores a plurality of scenes that are defined in advance. The storage unit 206 stores a plurality of learning models characterized by learning data.

### [Terminal]

A detailed description of the terminal 20 will be omitted. Examples of the terminal 20 include a portable terminal device such as a smartphone, a portable phone, a game console, or a tablet and a computer (a personal computer or a laptop computer). The terminal 20 can be any equipment or device as long as the terminal 20 can accept an operation by a user and can communicate with the server apparatus 10.

Next, variations according to the first example embodiment will be described.

### Variation 1 According to the First Example Embodiment

The server apparatus 10 may generate a history of the scene and the learning model selected by a user (selection history of scene, and so on) and a conversation history between the user and the learning model. The server apparatus 10 may provide a service to the user by utilizing the generated selection history of scene, and so on and conversation history.

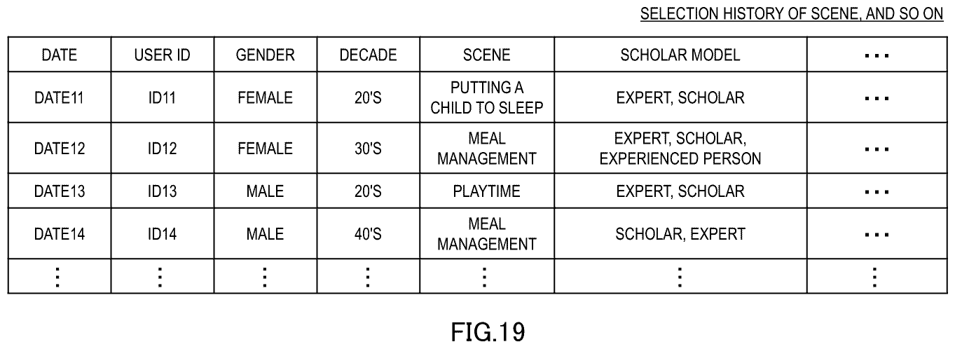

In the case where the service control unit 205 generates the selection history of scene, and so on, the service control unit 205 accumulates a combination of information related to the user of child rearing support service (for example, user ID, gender, and age) and the scene and the learning model selected by the user. The service control unit 205 generates the scene selection history of scene, and so on as shown in FIG. 19.

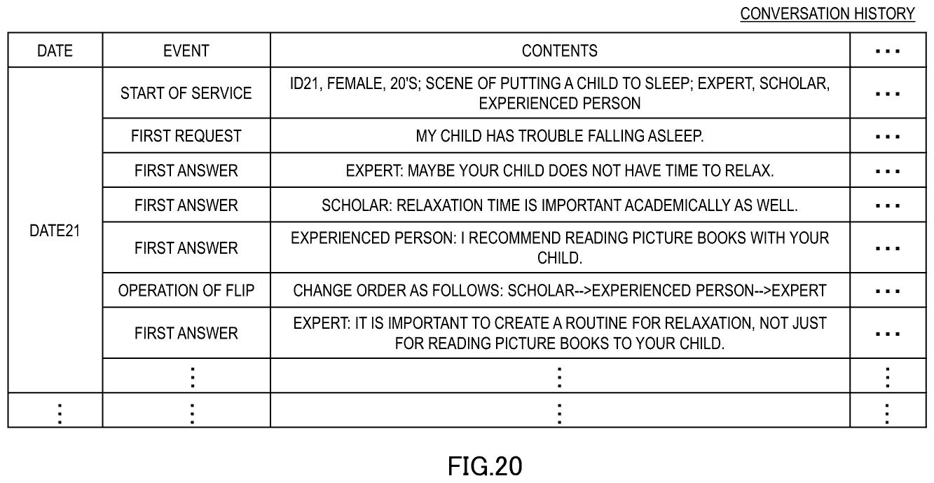

Alternatively, in the case where the service control unit 205 generates the conversation history, the service control unit 205 stores an event that occurred and the content of the event. For example, in the case where the service control unit 205 stores the start of the service, the service control unit 205 stores the information of the user, the selected scene, the selected scholar model, and so on. In addition, the service control unit 205 stores the statements of the user and the learning models. Furthermore, the service control unit 205 stores the operation by the user (intervention function, flip function) and the contents of the operation. For example, the service control unit 205 generates the conversation history as shown in FIG. 20.

### Variation 2 According to the First Example Embodiment

The above example embodiments describes a case in which a system administrator or the like defines a scene in advance and registers the defined scene in the server apparatus 10. However, the server apparatus 10 may generate a new scene. For example, the server apparatus 10 may generate (define) the new scene by analyzing history information (for example, selection history of scene, and so on, conversation history, and so on) acquired as a result of providing a service (child-rearing support service) to a large number of users.

The scene management unit 203 analyzes the above stored conversation history between the user and the learning model. For example, the scene management unit 203 calculates the average number of questions (requests from the user) per scene in one service provision. The scene management unit 203 determines whether there is a scene in which the calculated average value is greater than a predetermined value (threshold value).

The scene management unit 203 determines that a scene with a number of questions greater than the predetermined value requires subdivision of the scene. The fact that many questions are required until the user acquires the answer he or she expects from the learning model indicates that there is room for improvement in the scene.

For example, if the average number of questions in a scene of playtime is higher than the threshold value, the scene management unit 203 subdivides and redefines the scene of playtime. At that time, the scene management unit 203 may subdivide the scene using attribute information (for example, gender or age) of the user who has selected the scene subject to subdivision.

For example, in the case where the number of questions differs significantly between males and females even in the same scene, the scene management unit 203 may redefine (generate) the scene for each gender. Alternatively, in the case where the number of questions differs according to decade of the user, the scene management unit 203 may redefine (generate) a scene for each age.

For example, the scene management unit 203 may generate a scene of playtime (father), a scene of playtime (mother), and so on with respect to the scene of playtime.

Alternatively, in the case where the account control unit 204 has acquired information on occupation, interests, and so on of the user, the scene management unit 203 may generate a new scene by using these attribute information. For example, the scene management unit 203 may generate a scene of playtime (full-time housewife), a scene of playtime (self-employed), a scene of playtime (office worker), and so on.

In this way, the scene management unit 203 may generate the new scene based on the attribute information of the user, the conversation history between the user and the learning model, and so on.

### Variation 3 According to the First Example Embodiment

In the case where a user selects a scene, the service control unit 205 may narrow down (discard and select) the order of scenes to be displayed in a list or the scenes to be listed in accordance with the attribute information, and so on of the user.

For example, the service control unit 205 may determine the order in which scenes are displayed in the list according to the decade of the user. For example, the service control unit 205 reads out the decade of the user who is trying to select a scene from the user management database (the decade is calculated from the date of birth).

The service control unit 205 analyzes the selection history of scene, and so on, and calculates, for each scene, the number of times the scene has been selected by other users who belong to the decade of the user. The service control unit 205 displays a list of scenes in accordance with the calculated number of times the scene has been selected. For example, the service control unit 205 displays the list of scenes in descending order of the number of times the scene has been selected (in order of the number of times the scene has been selected).

Alternatively, the service control unit 205 may determine whether or not to display a list of scenes in accordance with the gender of the user. For example, in the case where the scene of playtime has been separated by male and female, as described above, the service control unit 205 may select the scene of playtime to be displayed in the list in accordance with the gender of the user. Specifically, the service control unit 205 excludes the scene of playtime for a gender different from the gender of the user.

Here, the service control unit 205 may use the learning model (scene selection model) prepared in advance with respect to selecting the scene to be presented to the user and the order of selecting the scene. The service control unit 205 may input the attribute information of the user (the user who has started using the child rearing support service) into the scene selection model, and acquire the scene and its order in accordance with the attribute of the user from the scene selection model.

Note that the selection history of scene, and so on, of the child rearing support service and conversation history can be used as the learning data for the scene selection model. For example, the selection history of scene, and so on, which is a combination of a large amount of accumulated attribute information and selected scenes, can be used as learning data for the scene selection model.

Even if a large amount of learning data is not acquired, the server apparatus 10 can use online optimization techniques, such as Bayesian optimization and the like, to recommend the scene to the user, in the case where the user starts using the service, and learn while receiving feedback. Specifically, the server apparatus 10 analyzes the conversation history between the user and the learning model (instruction of the user and feedback from the learning model) and adaptively selects the scene to be suggested to the user. Alternatively, the server apparatus 10 may select a statistically optimal scene based on the scenes already presented to the user and the selection rate of each scene, and present the selected scene to the user.

In this way, the user may select the scene that meets his or her concern, and so on, from among the scenes registered in advance in the server apparatus 10. Alternatively, the server apparatus 10 may suggest the scene to the user based on the attribute, and so on of the user.

### Variation 4 According to the First Example Embodiment

In the above example embodiment, it is described that in the case where the user receives the child-rearing support service, the user selects the learning models to become question partners. However, the selection does not have to be made. The server apparatus 10 may set each learning model implemented in advance in the server apparatus 10 to be the learning models that answer a question from the user.

Alternatively, the server apparatus 10 may select the learning models that becomes the question partners of the user. For example, the service control unit 205 may select a plurality of learning models (combinations of learning models) to become the question partners of the user in accordance with the attribute information of the user (for example, gender or age). Alternatively, the service control unit 205 may select the plurality of learning models in accordance with the scene selected by the user.

Alternatively, the server apparatus 10 (the service control unit 205) may narrow down the learning models to be presented to the user or may determine the order in which the learning models are displayed in the list, in accordance with the attribute information of the user. For example, the service control unit 205 may analyze the scene, and so on, selection history, and preferentially present the learning models that are popular with the user of the same gender and decade as the user (learning models that have been selected more frequently by other users).

### Variation 5 According to the First Example Embodiment

The server apparatus 10 may calculate an index to evaluate each learning model in accordance with a conversation with the user or an evaluation from the user. For example, the service control unit 205 acquires a confidence level (probability) along with an output (answer) from each learning model. The service control unit 205 stores the output of the learning model and the confidence level in the conversation history.

The service control unit 205 calculates the average value of the confidence level output by each learning model by referring to the conversation history, with respect to the scene selected by the user. With regard to the learning model for which the average value is lower than a threshold value, the service control unit 205 determines that it is inappropriate to answer the scene selected by the user. The service control unit 205 makes the learning model that the service control unit 205 has determined to be inappropriate unavailable for selection by the user or displays it at a lower level in a list.

Alternatively, the service control unit 205 may acquire the evaluation of the learning model selected by the user at the time the user terminates the service. The service control unit 205 may conduct a survey related to the learning models. For example, the service control unit 205 acquires the evaluation of the user on three levels of “good”, “normal”, and “bad” for each learning model selected by the user.

The service control unit 205 quantifies the acquired evaluation and reflects the quantified evaluation in the learning model management database. For example, the service control unit 205 quantifies the evaluation as follows: good=1 point, normal=0 point, and bad=−1 point. The service control unit 205 stores the quantified evaluation and the scene in association with each other (adding or subtracting from the evaluation score of the scene).

In the case where the service control unit 205 proposes the learning model to the user, the service control unit 205 excludes the learning model with a low evaluation of the scene selected by the user from its proposal.

In this way, in the case where the server apparatus 10 proposes the learning model to the user, the server apparatus 10 may select the learning model to propose to the user in accordance with the evaluation of each learning model (confidence level of each scene, evaluation from the user).

### Variation 6 According to the First Example Embodiment

In the above example embodiment, it is described that the server apparatus 10 realizes the conversation between the user and the learning models using the basic function, the intervention function, and the flip function. However, the server apparatus 10 may realize the conversation between the user and the learning models using other functions. The server apparatus 10 may provide the child-rearing support service to the user using other functions.

For example, the service control unit 205 of the server apparatus 10 may include a “give-up function”, a “debate function”, a “thumb-up function”, a “direct function”, a “dialogue function”, and the like.

The give-up function is a function that prevents (gives up) presenting an answer acquired from a certain learning model in the case where the answer is not useful to the user. The answer is not useful, e.g., in such cases where the confidence level of the answer output by the learning model is extremely low.

The debate function acquires the second set of answers with reference to the first set of answers from each of the plurality of learning models. Note that the debate function may be further performed by referring to the second set of answers and beyond. The (n+1)th set of answers is acquired by performing the debate function by referring to the (n)th set of answers. It should be noted that the nth set of answers in the debate function and the nth set of answers in the intervention function described above may differ because information to be referenced to the learning model is different. Furthermore, in the debate function, the second set of answers and beyond are acquired without user intervention, whereas in the intervention function, the second set of answers and beyond are acquired by user intervention.

The thumb-up function presents a summary (thumb-up) of the answers from the plurality of learning models. In the thumb-up function, at least the first set of answers is summarized, and in the case where up to the nth set of answers has been acquired, the first set of answers through the nth set of answers are summarized.

The direct function allows the user to directly specify the learning model and the answer to which the learning model refers. Specifically, the user selects one answer from among the answers from the plurality of learning models. In addition, the user selects the learning model that will provide the answer by referring to the selected answer (a learning model different from the learning model that provided the above selected answer). The selected learning model outputs a new answer by referring to the answers of other learning model selected by the user. For example, in FIG. 5, consider the case where the user selects the expert model and the expert model answers by referring to the answer of the scholar model. In this case, the user drags the icon corresponding to the expert model to the icon of the scholar model or the answer of the scholar model. The expert model answers the query that is generated based on the first request of the user, the scene, and the first answer of the scholar model. Note that unlike the flip function, the direct function does not change the order in which the learning models answer. In the example shown in FIG. 5 and so on, the order in which the expert model, the scholar model, and the experienced person model answer is maintained.

The dialogue function is a function in which an operator associated with any of the learning models directly dialogues with the user on behalf of the learning model. The dialogue function may be initiated by a request from the user or by a request from the operator.

As described above, situations that may occur in child rearing are defined by a plurality of scenes, and the plurality of scenes are stored in the server apparatus 10. The server apparatus 10 acquires the scene related to the concern, and so on, of the user from the user who wishes to use the child-rearing support service. In the case where the server apparatus 10 acquires an answer from the selected learning models by user, the server apparatus 10 generates a query to be input into the learning models based on the scene. That is, the server apparatus 10 restricts the answers of the learning models according to the scene. As a result, the answer from each learning model is prevented from going off on topics that the user does not intend. In particular, a generative AI such as a large-scale language model has the ability to answer to situations that may have little relevance to the situation assumed by the user, and may give an answer that is not expected by the user if there is no restriction by using the scene. In this regard, the server apparatus 10 uses the scene to guide (lead) the answer of the learning model to the answer that the user expects. In addition, since the user can acquire an appropriate answer from the learning model by selecting the scene once, in the case where the user enters a question to the learning models, the user does not need to enter the background, and so on, of the question in detail. As a result, convenience for the user of the child-rearing support service is improved.

Furthermore, the server apparatus 10 answers the request of the user by using the plurality of learning models selected by the user. The plurality of learning models are characterized by the learning data. The server apparatus 10 can provide the user with a wide variety of answers based on different standpoints and different ideas. As a result, the user can refer to the answer that is most suitable for his or her situation, and so on, from among the plurality of answers.

### Second Example Embodiment

Next, a second example embodiment will be described in detail with reference to drawings.

The first example embodiment describes the case in which the user and the learning models have a conversation with respect to a specific theme and scene. In the second example embodiment, a case in which the user has a conversation with a person will be described. In the second example embodiment, the user can resolve a concern, and so on, by having an actual conversation with a supporter who has agreed in advance to support the user.

As the information processing system according to the second example embodiment can have the same configuration as that according to the first example embodiment, the description corresponding to FIG. 3 will be omitted.

The following description will be made with a focus on the difference between the first example embodiment and the second example embodiment.

In the second example embodiment, a history related to a conversation between the user and the learning models (conversation history) are stored in the storage unit 206. The service control unit 205 stores requests and answers exchanged between the user and at least two or more learning models in the storage unit 206 as the conversation history.

The learning model management database according to the second example embodiment stores information related to supporter candidates who will support the user for each of the plurality of learning models. For example, the learning model management database stores contact information, and so on, of a sender of the learning data used to generate the learning model, who has consented to support the user.

For example, in the example in FIG. 11, in the case where expert A agrees to support the user (agrees to become the supporter), the telephone number, e-mail address, and so on of expert A are stored in the learning model management database as contact information for the supporter candidate.

Alternatively, the learning model management database may store a profile (attribute information) of each potential supporter. For example, the name, gender, date of birth, occupation, and so on of the supporter candidate may be stored in the learning model management database.

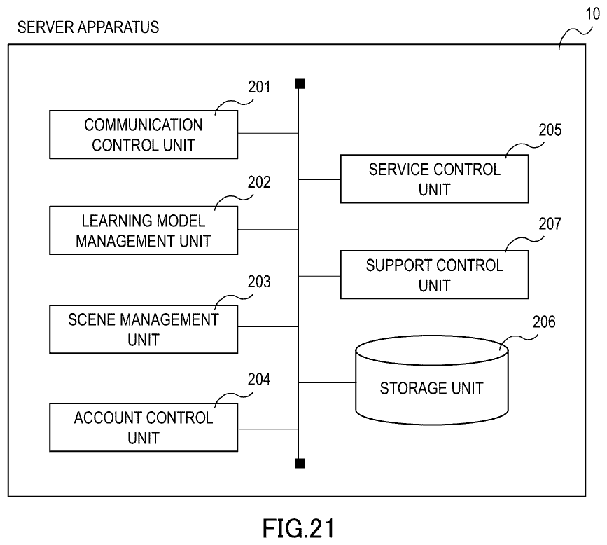

FIG. 21 is a diagram illustrating an example of a processing configuration (processing modules) of the server apparatus 10 according to an example embodiment of the present application. Referring to FIG. 21, a support control unit 207 is added to the configuration of the server apparatus 10 according to the first example embodiment.

The support control unit 207 is means for performing control related to supporting the user of the child rearing support service.

For example, the support control unit 207 supports the user who wishes to talk with an actual person (a supporter) instead of talking with the learning models. More specifically, the support control unit 207 analyzes the conversation history to determine the supporter to support the user from among a plurality of supporter candidates stored in the learning model management database.

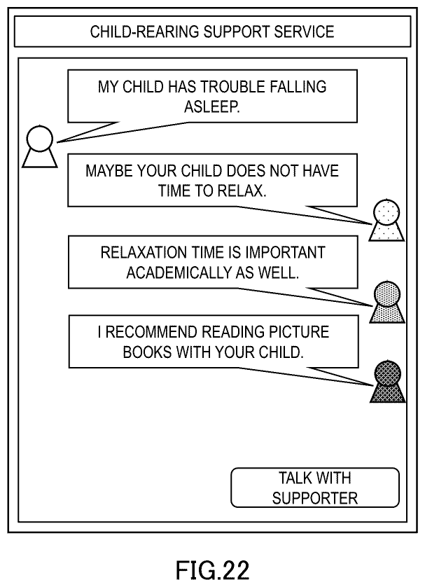

The support control unit 207 displays a button on the terminal 20 for the user to press in the case where the user wishes to have a conversation with the supporter (see FIG. 22). For example, if the “Talk with Supporter” button shown in FIG. 22 is pressed, the support control unit 207 performs control to realize a conversation between the user and the supporter.

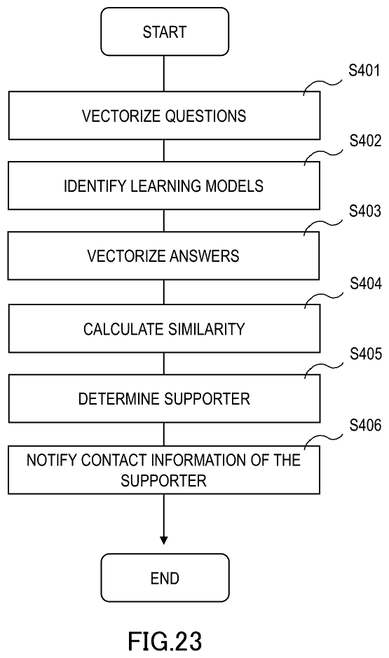

FIG. 23 is a flowchart illustrating an example of an operation of the support control unit 207 according to an example embodiment of the present application. Referring to FIG. 23, the operation of the support control unit 207 will be described.

The support control unit 207 vectorizes questions (requests) of the user (the user who wishes to have a conversation with the supporter) stored in the conversation history (step S401).

Furthermore, the support control unit 207 identifies the learning models corresponding to the supporter candidates who has “consented to be the supporter” in the learning model management database (step S402). For example, in the example in FIG. 11, if expert A and person with child-rearing experience C are set as supporter candidates, the expert model and the experienced person model corresponding to the two supporter candidates are identified.

The support control unit 207 vectorizes the answers of the above-identified learning models in the history of the learning model stored in the conversation history (step S403). The answers used to vectorize the answers may be the answers that the learning models have output to the user who wishes to have the conversation with the supporter, or the answers may be the answers that the learning models have output to another user.

Note that a detailed description will be omitted since existing techniques can be applied to vectorize text data. For example, existing embedding models such as Word2Vec, FastText, and GloVe, as well as transformer-type models such as BERT, ROBERTa, and GPT can be used to vectorize text data for the user or the learning models. The support control unit 207 calculates a similarity between

vectors generated from the questions of the user and each of at least one or more vectors generated from the answers of each learning models (step S404). The support control unit 207 calculates metrics such as cosine similarity and Euclidean distance as the similarity. By calculating the similarity, the support control unit 207 calculates the similarity between the concern, and so on, held by the user and the answers of the supporter candidates.

The support control unit 207 determines the supporter who will support the user by using the calculated similarities (step S405). For example, the supporter candidate corresponding to the learning model with the highest calculated similarity is determined as the supporter.

The support control unit 207 notifies the user of contact information (telephone number and e-mail address) of the determined supporter (step S406). For example, the support control unit 207 displays the contact information of the supporter on the terminal 20.

The user calls the notified telephone number or transmits an e-mail to the notified e-mail address. The user contacts the supporter and consults with the supporter with respect to his or her concern, and so on.

In this way, the support control unit 207 calculates a first vector related to the requests of the user stored in the conversation history (a vector related to the requests of the user). The support control unit 207 calculates at least two or more second vectors related to the answers of each of at least two or more learning models stored in the conversation history (vectors related to the answers of each of a plurality of selected learning models by the user). The support control unit 207 calculates similarities between the first vector and each of the at least two or more second vectors. The support control unit 207 determines the supporter to support the user from among the stored supporter candidates based on the calculated similarities. More specifically, the support control unit 207 determines the supporter candidate stored in association with the learning model corresponding to the second vector with the highest similarity between the first vector and the second vectors as the supporter to support the user.

The supporter corresponding to the learning model that has provided the highly similar answer to the question of the user who wishes to have a conversation with the supporter is likely to be able to provide appropriate advice, and so on, to the concern, and so on, of the user. Therefore, the support control unit 207 analyzes the conversation history between the user and the learning models to extract the most suitable supporter as the conversation partner for the user, and notifies the user of the contact information, and so on, of the extracted supporter. Next, variations according to the second example embodiment will be described.

### Variation 1 According to the Second Example Embodiment

In the above example embodiments, the case in which the provider (sender) of the learning data on which generation of the learning model is based and the supporter candidate are the same person is described. However, the provider (sender) of the learning data and the supporter candidate may be different persons.

For example, a person who has a similar idea to the provider of the learning data (the source of the learning data) or a person who agrees with the idea of the provider of the learning data may be stored in the learning model management database as the supporter candidate.

For example, a plurality of persons such as supporter candidate A1 and supporter candidate A2, who share the ideas of expert A, may be stored in the learning model management database as supporter candidates corresponding to the expert model. Alternatively, a friend, an acquaintance, or the like who belongs to the same community as person with child-rearing experience C may be stored in the learning model management database as the supporter candidate.

In the case where a plurality of supporter candidates are set for the learning model with the highest calculated similarity, the support control unit 207 may notify the user of the contact information for each of the plurality of supporter candidates. Alternatively, the support control unit 207 may notify the user of the contact information of the supporter candidate selected by the user from among the plurality of supporter candidates. At that time, the support control unit 207 may display a profile, or the like, of each supporter candidate on the terminal 20 together with the contact information of the supporter candidate.

### Variation 2 According to the Second Example Embodiment

The support control unit 207 may use attribute information of the user and attribute information of the supporter candidates at the timing of determining the supporter candidate or the supporter.

For example, the support control unit 207 extracts the supporter candidates that have the same attributes as the attributes of the user (gender, decade, and so on) from the learning model management database. The support control unit 207 may vectorize the answers of the learning models corresponding to the extracted supporter candidates and determine the supporter.

### Variation 3 According to the Second Example Embodiment

The server apparatus 10 may provide an interface in which a plurality of supporter candidates are presented to the user, and the user selects the final supporter from among the plurality of supporter candidates presented to the user.

For example, the support control unit 207 extracts the supporter candidate with the highest similarity in magnitude among the above calculated similarities. The support control unit 207 displays the extracted supporter candidates on the terminal 20 while accepting a selection of the supporter from the user. The support control unit 207 displays contact information of the supporter candidate selected by the user on the terminal 20.

### Variation 4 According to the Second Example Embodiment

At the timing of vectorizing the answers of the learning model, the support control unit 207 may assign weights to the learning models themselves or to the answers of the learning models based on an operation, and so on by the user. For example, the support control unit 207 may calculate the vector by assigning a higher weight to the learning model whose order of answers has been changed by the user through a flip operation than to the weights of the other learning models. In this case, the support control unit 207 assigns a higher weight of each answer of the learning model than the weights of the answers of the other learning models.

Alternatively, the support control unit 207 may increase the weight of the answer of the learning model after the order is changed. The support control unit 207 may increase only the weight of the answer of the learning model made immediately after the order is changed.

In this way, the support control unit 207 may assign weights to each of the at least two or more learning models, at the timing of calculating the at least two or more second vectors. At that time, in the case where the user has changed the order of answers of the at least two or more learning models, the support control unit 207 may assign a heavier weight to the learning model for which the user has changed the order of answers than to the learning model for which the user has not changed the order of answers.

The learning model whose order of answers is changed by the flip function is the learning model that has attracted a lot of attention from users. For example, the learning model whose order of answers is set to the last by the flip function is the learning model in which the users have a strong interest. Therefore, at the timing of vectorizing the answers of each learning model, the support control unit 207 increases the weight of the learning model in which the user has a strong interest, thereby more accurately extracting the supporter who is most likely to solve the concern, and so on, of the user.

### Variation 5 According to the Second Example Embodiment

The server apparatus 10 may provide a service to support the supporter in answering a question from the user.

The supporter utilizes the child-rearing support services provided by the server apparatus 10 in the same way as the user who has contacted him or her. For example, at the time of providing corroboration or reinforcement of an answer to a question received from the user, the supporter uses the child-rearing support service.

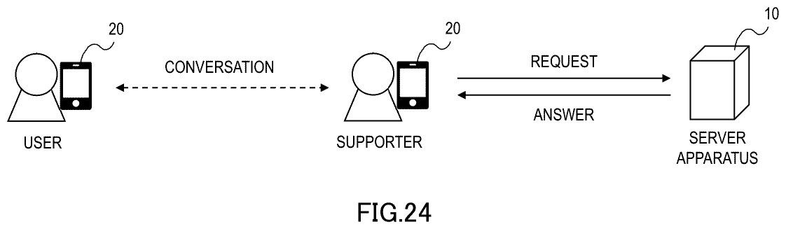

For example, as shown in FIG. 24, the user and the supporter are conversing using their respective terminals 20. The user consults the supporter, saying, “I feel like my child is slow to start talking. I'm concerned about this delay.”

For example, the supporter responds to the question from the user by asking, “Have you tried consulting a doctor?”.

At that time, the supporter enters “Please introduce me to a specialist in developmental disorders” into the server apparatus 10.

The supporter selects the answer appropriate for the situation of the user from among a plurality of answers (answers output by the plurality of learning models) acquired from the server apparatus 10 and relays the answer to the user. The server apparatus 10 may also automatically generate a question of the content to be input based on a dialogue history between the supporter and the user. For example, the server apparatus 10 may automatically output an answer to the automatically generated question, “Please introduce me to a specialist in developmental disorders,” in response to the answer from the supporter, “Have you tried consulting a doctor?”. This feature allows the supporter to automatically acquire the answer he or she needs, thus enabling faster and more accurate support.

Alternatively, the user may utilize child-rearing support services while conversing with the supporter (during the conversation).

In this way, the supporter can utilize the child-rearing support service and thereby provide more beneficial information to the user.

### Variation 6 According to the Second Example Embodiment

The support control unit 207 may not only introduce the supporter (notify contact information) to the user with a concern, and so on, but may also introduce a product or service that can help to solve the concern, and so on, of the user.

For example, the support control unit 207, upon detecting a predetermined action by the user (for example, pressing a product introduction button), introduces a product or service to the user that corresponds to the past questions, and so on, of the user.

For example, in a similar manner to the above, the support control unit 207 vectorizes the questions of the user and vectorizes the answers of the learning models. The support control unit 207 identifies the learning model that provided the answer that is closest to the concern, and so on, of the user from the vector of the user and at least one or more learning models.

The support control unit 207 generates a query for the identified learning model that requests a suggestion for the product corresponding to the past question of the user. For example, the support control unit 207 generates a query such as, “My child has trouble falling asleep. Could you please recommend a product for me?”. By inputting the generated query into the above identified learning model, the support control unit 207 can suggest the product, and so on, suitable for the user from the learning model that has answered the concern, and so on, of the user accurately.

As described above, the server apparatus 10 according to the second example embodiment supports the user by using the conversation history, and so on between the user and the learning models. In particular, the server apparatus 10 supports the user who wishes to have a conversation with a real person (supporter) rather than the learning models. At that time, the server apparatus 10 analyzes the conversation history and introduces the supporter who is most likely to provide the most appropriate answer to the question (request) of the user. As a result, the user can acquire appropriate advice, and so on, from the supporter who is familiar with his or her concern, and so on. In other words, convenience for the user is improved.

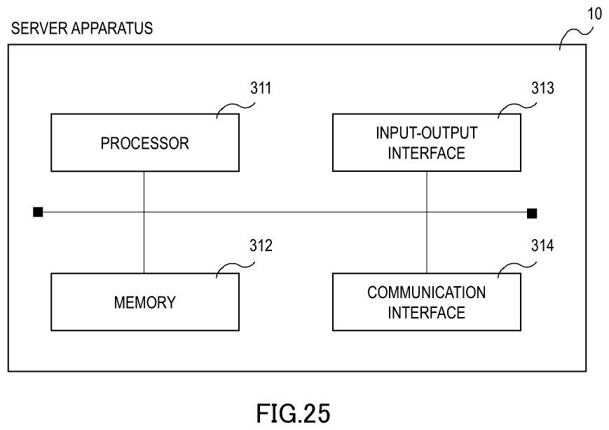

Next, a hardware configuration of an individual apparatus that constitutes the information processing system will be described. FIG. 25 is a diagram illustrating an example of a hardware configuration of the server apparatus 10.

The server apparatus 10 can be configured by an information processing apparatus (a so-called computer) and has a configuration illustrated as an example in FIG. 25. For example, the server apparatus 10 includes a processor 311, a memory 312, an input-output interface 313, a communication interface 314, and so on. The components such as the processor 311 are connected to an internal bus, and so on so that these components can communicate with each other.

The hardware configuration of the server apparatus 10 is not limited to the configuration illustrated in FIG. 25. The server apparatus 10 may include hardware not illustrated or may be configured without the input-output interface 313 if desired. In addition, the number of components, such as the number of processors 311, included in the server apparatus 10 is not limited to the example illustrated in FIG. 25. For example, a plurality of processors 311 may be included in the server apparatus 10.

The processor 311 is a programmable device such as a CPU (Central Processing Unit), an MPU (Micro Processing Unit), a DSP (Digital Signal Processor), a TPU (Tensor Processing Unit), a GPU (Graphics Processing Unit (GPU), or the like. Alternatively, the processor 311 may be a device such as an FPGA (Field Programmable Gate Array) or an ASIC (Application Specific Integrated Circuit). The processor 311 executes various kinds of programs including an operating system (OS).

The memory 312 is a RAM (Random Access Memory), a ROM (Read-Only Memory), an HDD (Hard Disk Drive), an SSD (Solid State Drive), or the like. The memory 312 stores an OS program, an application program, and various kinds of data.

The input-output interface 313 is an interface for a display apparatus and an input apparatus not illustrated. For example, the display apparatus is a liquid crystal display and so on. For example, the input apparatus is an apparatus that receives user operations, and examples of the input apparatus include a keyboard and a mouse.

The communication interface 314 is a circuit, a module, and so on for performing communication with other apparatuses. For example, the communication interface 314 includes a NIC (Network Interface Card) and so on.

The functions of the server apparatus 10 are realized by various kinds of processing modules. The processing modules are realized, for example, by causing the processor 311 to execute a program stored in the memory 312. In addition, this program can be recorded in a computer-readable storage medium. The storage medium may be a non-transient (non-transitory) storage medium, such as a semiconductor memory, a hard disk, a magnetic recording medium, or an optical recording medium. That is, the present invention can be embodied as a computer program product. In addition, the above program may be updated by downloading a program via a network or by using a storage medium in which a program is stored. In addition, the above processing modules may be realized by semiconductor chips.

Note that as is the case with the server apparatus 10, the terminal 20 can each be configured by an information processing apparatus, and the basic hardware configuration of the terminal 20 is the same as that of the server apparatus 10. Thus, description of the basic hardware configuration of the terminal 20 will be omitted.

The server apparatus 10 which is an information processing device includes a computer and can realize its functions by causing the computer to execute a program. In addition, the server apparatus 10 executes a control method of the server apparatus 10 by using this program.

### [Variations]

The configurations, operations, and so on of the information processing system according to the above example embodiments are examples and do not limit the present system configuration, and so on.

The above example embodiments describe the operation, and so on of the information processing system of the present application using the child-rearing support service as an example. However, the information processing system of the present application can also be applied to services different from the child-rearing support service. For example, the information processing system of the present application can be applied to any service in which a user inputs a question, or the like, and the learning model answers the question, such as an employment support service, a career change support service, a legal consultation service, and the like.

In the above example embodiments, the case in which a single expert model is generated from statements by a single expert is described. However, it goes without saying that a plurality of expert models may be generated from the statements, and so on of each of the plurality of experts. Similarly, a plurality of scholar models may be generated from the statements of the plurality of scholars, and a plurality of experienced person models may be generated from the statements of the plurality of persons with child-rearing experience.

Alternatively, the single expert model may be generated from the statements, and so on, of the plurality of experts. For example, a plurality of experts with similar tendencies of ways of thinking may be assigned to one group, and the expert model may be generated for each group.

In the case where the plurality of learning models are selected, the server apparatus 10 may provide an interface that allows the user to determine the order of answers with respect to the plurality of learning models. That is, the user may determine which learning model the user wants answered first and which learning model the user wants answered last.

The server apparatus 10 may perform control to determine the order of answers with respect to the plurality of learning models selected by the user before the server apparatus 10 performs the basic function. Specifically, the server apparatus 10 inputs a query based on the request of the user and the scene to each of the plurality of learning models selected by the user. The server apparatus 10 acquires confidence levels for the same query from each of the learning models. The server apparatus 10 sets the order of the learning models with the lowest confidence level to the order of the learning models to be adopted in the basic model. For example, if the confidence level of each of the expert model, the scholar model, and the experienced person model is highest in the order of the expert model, the experienced person model, and the scholar model, then the server apparatus 10 (the service control unit 205) sets the order of the answers of the learning models to the scholar model, the experienced person model, and the expert model, in that order. The server apparatus 10 may input the same query into each learning model and set the learning model least likely to answer appropriately with respect to the scene selected by the user as the first learning model and the learning model most likely to answer appropriately as the last learning model.

The above example embodiments describe in the case where the user management database, or the like, is configured inside the server apparatus 10, but the database may be established on an external database server, or the like. That is, some of the functions of the server apparatus 10 may be implemented in another server. More specifically, the “service control unit (service control means)”, and so on described above, can be implemented in any of the apparatuses included in the system.

While the data exchange between each apparatus (for example, the server apparatus 10 and the terminal 20) is not limited to any particular mode, data exchanged between these apparatuses may be encrypted. It is desirable that personal information of a user, and so on are transmitted and received between these apparatuses and encrypted data is transmitted and received in order to properly protect this information.

In the flowcharts and sequence diagrams used in the above description, a plurality of steps (processes) are sequentially described.

However, the order of the execution of the steps performed in the individual example embodiment is not limited to the described order. In the individual example embodiment, the order of the illustrated steps may be changed to the extent that a problem is not caused on the content of the individual example embodiment. For example, individual processes may be executed in parallel.

The above example embodiments have been described in detail to facilitate the understanding of the present application disclosed and not to mean that all the configurations described above are needed. In addition, if a plurality of example embodiments have been described, each of the example embodiments may be used individually or a plurality of example embodiments may be used in combination. For example, part of a configuration according to one example embodiment may be replaced by a configuration according to another example embodiment. For example, a configuration according to one example embodiment may be added to a configuration according to another example embodiment. In addition, addition, deletion, or replacement is possible between part of a configuration according to one example embodiment and another configuration.

The industrial applicability of the present invention has been made apparent by the above description. That is, the present invention is suitably applicable to information processing systems that support users.

A part or the entirety of the example embodiments described above may be described as in the following supplementary notes, but is not limited to the followings.

### Supplementary Note 1

A server apparatus, including:
a request acquiring means that acquires a request related to a specific theme from a user, which is a first request to at least two or more learning models;
an answer acquiring means that acquires answers from each of the at least two or more learning models by using at least a scene showing a situation related to the specific theme and the first request; and an answer providing means that provides the answers acquired from each of the at least two or more learning models to the user.

### Supplementary Note 2

The server apparatus according to supplementary note 1, wherein the answer acquiring means generates a first query to be input to a first learning model among the at least two or more learning models based on the scene and the first request, and acquires a first answer from the first learning model by inputting the generated first query into the first learning model, and
wherein the answer acquiring means generates a second query to be input to a second learning model among the at least two or more learning models based on the scene, the first request and the first answer, and acquires a second answer from the second learning model by inputting the generated second query into the second learning model, and wherein the answer providing means provides the first and second answers to the user.

### Supplementary Note 3

The server apparatus according to supplementary note 2, wherein the request acquiring means acquires a second request from the user to whom the first and second answers are provided, and
wherein the answer acquiring means generates a third query to be input into the first learning model based on the scene, the second request, and the first and/or second answers, and acquires a third answer from the first learning model by inputting the generated third query into the first learning model, and
wherein the answer acquiring means generates a fourth query to be input to the second learning model based on the scene, the second request, the third answer, and the first and/or second answers, and acquires a fourth answer from the second learning model by inputting the generated fourth query into the second learning model.

### [Supplementary Note 4]

The server apparatus according to supplementary note 2, further including a change instruction acquiring means that acquires an instruction indicating to change an order of answers of the first and second learning models from the user to whom the first and second answers have been provided, and
wherein the answer acquiring means generates a third query to be input to the first learning model based on the scene, the first request, and the second answer, and acquires a third answer from the first learning model by inputting the generated third query into the first learning model.

### Supplementary Note 5

The server apparatus according to any one of supplementary notes 1 to 4, further including:
a scene selection control means that acquires the scene selected by the user from among a plurality of scenes that are defined in advance; and
a learning model selection control means that acquires the at least two or more learning models selected by the user from among a plurality of learning models characterized by learning data.

### Supplementary Note 6

The server apparatus according to supplementary note 1, further including:
a storing means that stores information related to supporter candidates who will support the user for each of the at least two or more learning models; and
a support control means that determines a supporter to support the user from among the stored supporter candidates by analyzing a conversation history including requests and answers exchanged between the user and the at least two or more learning models.

### Supplementary Note 7

The server apparatus according to supplementary note 6, wherein the support control means calculates a first vector related to the requests of the user stored in the conversation history, and calculates at least two or more second vectors related to the answers of each of the at least two or more learning models included in the conversation history, and wherein
the support control means calculates similarities between the first vector and each of the at least two or more second vectors, and
wherein the support control means determines the supporter to support the user from among the stored supporter candidates based on the calculated similarities.

### Supplementary Note 8

The server apparatus according to supplementary note 7, wherein the support control means determines the supporter candidate stored in association with the learning model corresponding to the second vector with the highest similarity between the first vector and the second vectors as the supporter to support the user.

### Supplementary Note 9

The server apparatus according to supplementary note 8, wherein the support control means assigns weights to each of the at least two or more learning models at the timing of calculating the at least two or more second vectors.

### Supplementary Note 10

The server apparatus according to supplementary note 9, wherein, in the case where the user has changed an order of answers of the at least two or more learning models, the support control means assigns a heavier weight to the learning model for which the user has changed the order of answers than to the learning model for which the user has not changed the order of answers.

### Supplementary Note 11

A control method of a server apparatus, the control method including: a request acquiring step that acquires a request related to a specific theme from a user, which is a first request to at least two or more learning models;
an answer acquiring step that acquires answers from each of the at least two or more learning models by using at least a scene showing a situation related to the specific theme and the first request; and
an answer providing step that provides the answers acquired from each of the at least two or more learning models to the user.

### Supplementary Note 12

The control method of the server apparatus according to supplementary note 11, wherein
the answer acquiring step generates a first query to be input to a first learning model among the at least two or more learning models based on the scene and the first request, and acquires a first answer from the first learning model by inputting the generated first query into the first learning model, and
wherein the answer acquiring step generates a second query to be input to a second learning model among the at least two or more learning models based on the scene, the first request and the first answer, and acquires a second answer from the second learning model by inputting the generated second query into the second learning model, and
wherein the answer providing step provides the first and second answers to the user.

### Supplementary Note 13

The control method of the server apparatus according to supplementary note 12, wherein
the request acquiring step acquires a second request from the user to whom the first and second answers are provided, and
wherein the answer acquiring step generates a third query to be input into the first learning model based on the scene, the second request, and the first and/or second answers, and acquires a third answer from the first learning model by inputting the generated third query into the first learning model, and
wherein the answer acquiring step generates a fourth query to be input to the second learning model based on the scene, the second request, the third answer, and the first and/or second answers, and acquires a fourth answer from the second learning model by inputting the generated fourth query into the second learning model.

### Supplementary Note 14

The control method of the server apparatus according to supplementary note 12, further including a change instruction acquiring step that acquires an instruction indicating to change an order of answers of the first and second learning models from the user to whom the first and second answers have been provided, and
wherein the answer acquiring step generates a third query to be input to the first learning model based on the scene, the first request, and the second answer, and acquires a third answer from the first learning model by inputting the generated third query into the first learning model.

### Supplementary Note 15

The control method of the server apparatus according to any one of supplementary notes 11 to 14, further including:
a scene selection control step that acquires the scene selected by the user from among a plurality of scenes that are defined in advance; and
a learning model selection control step that acquires the at least two or more learning models selected by the user from among a plurality of learning models characterized by learning data.

### Supplementary Note 16

The control method of the server apparatus according to supplementary note 11, further including:
a storing step that stores information related to supporter candidates who will support the user for each of the at least two or more learning models; and
a support control step that determines a supporter to support the user from among the stored supporter candidates by analyzing a conversation history including requests and answers exchanged between the user and the at least two or more learning models.

### Supplementary Note 17

The control method of the server apparatus according to supplementary note 16, wherein
the support control step calculates a first vector related to the requests of the user stored in the conversation history, and calculates at least two or more second vectors related to the answers of each of the at least two or more learning models included in the conversation history, and wherein
the support control step calculates similarities between the first vector and each of the at least two or more second vectors, and
wherein the support control step determines the supporter to support the user from among the stored supporter candidates based on the calculated similarities.

### Supplementary Note 18

The control method of the server apparatus according to supplementary note 17, wherein the support control step determines the supporter candidate stored in association with the learning model corresponding to the second vector with the highest similarity between the first vector and the second vectors as the supporter to support the user.

### Supplementary Note 19

The control method of the server apparatus according to supplementary note 18, wherein the support control step assigns weights to each of the at least two or more learning models at the timing of calculating the at least two or more second vectors.

### Supplementary Note 20

The control method of the server apparatus according to supplementary note 19, wherein, in the case where the user has changed an order of answers of the at least two or more learning models, the support control step assigns a heavier weight to the learning model for which the user has changed the order of answers than to the learning model for which the user has not changed the order of answers.

### Supplementary Note 21

A program causing a computer mounted on a server apparatus to perform processing for:
a request acquiring processing that acquires a request related to a specific theme from a user, which is a first request to at least two or more learning models;
an answer acquiring processing that acquires answers from each of the at least two or more learning models by using at least a scene showing a situation related to the specific theme and the first request; and
an answer providing processing that provides the answers acquired from each of the at least two or more learning models to the user.

### Supplementary Note 22

The program according to supplementary note 21, wherein
the answer acquiring processing generates a first query to be input to a first learning model among the at least two or more learning models based on the scene and the first request, and acquires a first answer from the first learning model by inputting the generated first query into the first learning model, and
wherein the answer acquiring processing generates a second query to be input to a second learning model among the at least two or more learning models based on the scene, the first request and the first answer, and acquires a second answer from the second learning model by inputting the generated second query into the second learning model, and wherein the answer providing processing provides the first and second answers to the user.

### Supplementary Note 23

The program according to supplementary note 22, wherein
the request acquiring processing acquires a second request from the user to whom the first and second answers are provided, and
wherein the answer acquiring processing generates a third query to be input into the first learning model based on the scene, the second request, and the first and/or second answers, and acquires a third answer from the first learning model by inputting the generated third query into the first learning model, and
wherein the answer acquiring processing generates a fourth query to be input to the second learning model based on the scene, the second request, the third answer, and the first and/or second answers, and acquires a fourth answer from the second learning model by inputting the generated fourth query into the second learning model.

### Supplementary Note 24

The program according to supplementary note 22, further performing a change instruction acquiring processing that acquires an instruction indicating to change an order of answers of the first and second learning models from the user to whom the first and second answers have been provided, and
wherein the answer acquiring processing generates a third query to be input to the first learning model based on the scene, the first request, and the second answer, and acquires a third answer from the first learning model by inputting the generated third query into the first learning model.

### Supplementary Note 25

The program according to any one of supplementary notes 21 to 24, further performing:
a scene selection control processing that acquires the scene selected by the user from among a plurality of scenes that are defined in advance; and
a learning model selection control processing that acquires the at least two or more learning models selected by the user from among a plurality of learning models characterized by learning data.

### Supplementary Note 26

The program according to supplementary note 21, further performing:
a storing processing that stores information related to supporter candidates who will support the user for each of the at least two or more learning models; and
a support control processing that determines a supporter to support the user from among the stored supporter candidates by analyzing a conversation history including requests and answers exchanged between the user and the at least two or more learning models.

### Supplementary Note 27

The program according to supplementary note 26, wherein
the support control processing calculates a first vector related to the requests of the user stored in the conversation history, and calculates at least two or more second vectors related to the answers of each of the at least two or more learning models included in the conversation history, and
wherein
the support control processing calculates similarities between the first vector and each of the at least two or more second vectors, and
wherein the support control processing determines the supporter to support the user from among the stored supporter candidates based on the calculated similarities.

### Supplementary Note 28

The program apparatus according to supplementary note 27, wherein the support control processing determines the supporter candidate stored in association with the learning model corresponding to the second vector with the highest similarity between the first vector and the second vectors as the supporter to support the user.

### Supplementary Note 29

The program according to supplementary note 28, wherein the support control processing assigns weights to each of the at least two or more learning models at the timing of calculating the at least two or more second vectors.

### Supplementary Note 30

The server program according to supplementary note 29, wherein, in the case where the user has changed an order of answers of the at least two or more learning models, the support control processing assigns a heavier weight to the learning model for which the user has changed the order of answers than to the learning model for which the user has not changed the order of answers.

Furthermore, all or part of the configurations described in supplementary note 2 to supplementary note 10, which depend on supplementary note 1, may also depend on supplementary note 11 and supplementary note 21 in the same manner as supplementary note 2 to supplementary note 10. Furthermore, not limited to supplementary note 1, supplementary note 11, and supplementary note 21, within the scope that does not deviate from the embodiments described above, all or part of the configurations described as supplementary notes may similarly depend on various hardware, software, various recording means for recording software, or systems.

The entire disclosure of the above patent literature is incorporated herein by reference thereto. While the example embodiments of the present invention have thus been described, the present invention is not limited to these example embodiments. It is to be understood to those skilled in the art that these example embodiments are only examples and that various variations are possible without departing from the scope and spirit of the present invention. That is, the present invention of course includes various variations and modifications that could be made by those skilled in the art in accordance with the overall disclosure including the claims and the technical concept.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents. Further, it is noted that the inventor's intent is to retain all equivalents of the claimed disclosure even if the claims are amended during prosecution.

What is claimed is:

1. A server apparatus, comprising:
at least one memory storing a set of instructions; and
at least one processor configured to execute the set of instructions to:
acquire a request related to a specific theme from a user, which is a first request to at least two or more learning models;
acquire answers from each of the at least two or more learning models by using at least a scene showing a situation related to the specific theme and the first request; and
provide the answers acquired from each of the at least two or more learning models to the user.

2. The server apparatus according to claim 1, wherein
the at least one processor is further configured to execute the set of instructions to:
generate a first query to be input to a first learning model among the at least two or more learning models based on the scene and the first request, and acquires a first answer from the first learning model by inputting the generated first query into the first learning model;
generate a second query to be input to a second learning model among the at least two or more learning models based on the scene, the first request and the first answer, and acquires a second answer from the second learning model by inputting the generated second query into the second learning model; and
provide the first and second answers to the user.

3. The server apparatus according to claim 2, wherein
the at least one processor is further configured to execute the set of instructions to:
acquire a second request from the user to whom the first and second answers are provided;
generate a third query to be input into the first learning model based on the scene, the second request, and the first and/or second answers, and acquires a third answer from the first learning model by inputting the generated third query into the first learning model; and
generate a fourth query to be input to the second learning model based on the scene, the second request, the third answer, and the first and/or second answers, and acquire a fourth answer from the second learning model by inputting the generated fourth query into the second learning model.

4. The server apparatus according to claim 2, wherein
the at least one processor is further configured to execute the set of instructions to:
acquire an instruction indicating to change an order of answers of the first and second learning models from the user to whom the first and second answers have been provided; and
generate a third query to be input to the first learning model based on the scene, the first request, and the second answer, and acquire a third answer from the first learning model by inputting the generated third query into the first learning model.

5. The server apparatus according to claim 1, wherein
the at least one processor is further configured to execute the set of instructions to:
acquire the scene selected by the user from among a plurality of scenes that are defined in advance; and
acquire the at least two or more learning models selected by the user from among a plurality of learning models characterized by learning data.

6. The server apparatus according to claim 1, wherein
the at least one processor is further configured to execute the set of instructions to:
store information related to supporter candidates who will support the user for each of the at least two or more learning models; and
determine a supporter to support the user from among the stored supporter candidates by analyzing a conversation history including requests and answers exchanged between the user and the at least two or more learning models.

7. The server apparatus according to claim 6, wherein
the at least one processor is further configured to execute the set of instructions to:
calculate a first vector related to the requests of the user stored in the conversation history, and calculate at least two or more second vectors related to the answers of each of the at least two or more learning models included in the conversation history;
calculate similarities between the first vector and each of the at least two or more second vectors; and
determine the supporter to support the user from among the stored supporter candidates based on the calculated similarities.

8. The server apparatus according to claim 7, wherein
the at least one processor is further configured to execute the set of instructions to determine the supporter candidate stored in association with the learning model corresponding to the second vector with the highest similarity between the first vector and the second vectors as the supporter to support the user.

9. The server apparatus according to claim 8, wherein
the at least one processor is further configured to execute the set of instructions to assigns weights to each of the at least two or more learning models at the timing of calculating the at least two or more second vectors.

10. The server apparatus according to claim 9, wherein, in the case where the user has changed an order of answers of the at least two or more learning models, the at least one processor is further configured to execute the set of instructions to assign a heavier weight to the learning model for which the user has changed the order of answers than to the learning model for which the user has not changed the order of answers.

11. A control method of a server apparatus, the control method comprising:
acquiring a request related to a specific theme from a user, which is a first request to at least two or more learning models;
acquiring answers from each of the at least two or more learning models by using at least a scene showing a situation related to the specific theme and the first request; and
that providing the answers acquired from each of the at least two or more learning models to the user.

12. The control method of the server apparatus according to claim 11, the control method further comprising:
generating a first query to be input to a first learning model among the at least two or more learning models based on the scene and the first request, and acquires a first answer from the first learning model by inputting the generated first query into the first learning model;
generating a second query to be input to a second learning model among the at least two or more learning models based on the scene, the first request and the first answer, and acquiring a second answer from the second learning model by inputting the generated second query into the second learning model; and
providing the first and second answers to the user.

13. The control method of the server apparatus according to claim 12, the control method further comprising:
acquiring a second request from the user to whom the first and second answers are provided;
generating a third query to be input into the first learning model based on the scene, the second request, and the first and/or second answers, and acquiring a third answer from the first learning model by inputting the generated third query into the first learning model; and
generating a fourth query to be input to the second learning model based on the scene, the second request, the third answer, and the first and/or second answers, and acquiring a fourth answer from the second learning model by inputting the generated fourth query into the second learning model.

14. The control method of the server apparatus according to claim 12, the control method further comprising:
acquiring an instruction indicating to change an order of answers of the first and second learning models from the user to whom the first and second answers have been provided; and
generating a third query to be input to the first learning model based on the scene, the first request, and the second answer, and acquiring a third answer from the first learning model by inputting the generated third query into the first learning model.

15. A non-transitory computer-readable storage medium storing a program causing a computer mounted on a server apparatus to perform processing for:
acquiring a request related to a specific theme from a user, which is a first request to at least two or more learning models;
acquiring answers from each of the at least two or more learning models by using at least a scene showing a situation related to the specific theme and the first request; and
providing the answers acquired from each of the at least two or more learning models to the user.
